(19) United States
(12) Patent Application Publication
(10) Pub. No.: US 2005/0275867 A1
(43) Pub. Date: Dec. 15, 2005

(54) Printing apparatus, print control program, and storage medium storing the print control program

(76) Inventors: Masaki Higashiura, Yamatokoriyama-shi (JP); Wataru Nishii, Nara-shi (JP); Yusuke Nagai, Yamatokoriyama-shi (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/147,743

(22) Filed: Jun. 8, 2005

(30) Foreign Application Priority Data
Jun. 10, 2004 (JP) 2004-172890

(51) Int. Cl. G06F 15/00

(52) U.S. Cl. 358/1.14

(57) ABSTRACT

In a multi function printer, an upper limit of printable sheets is set for each user requesting a print job. The multi function printer includes a settings change instructing section for making an inquiry to a manager terminal whether to authorize changing the upper limit as requested by a user, and an authorization confirming section for confirming a reply to the inquiry, and changing the upper limit if the manager terminal authorizes the change. This reduces the cost of print job, and enables a print job to be efficiently carried out by changing print restrictions as required by the print job.

This Nonprovisional application claims priority under 35 U.S.C. § 119(a) on Patent Application No. 172890/2004 filed in Japan on Jun. 10, 2004, the entire contents of which are hereby incorporated by reference.

### FIELD OF THE INVENTION

The present invention relates to a printing apparatus connected to one or more user terminals via a network, a print control program, and a storage medium storing the print control program. Particularly, the present invention relates to multi function printing apparatus integrated multiple functions, and print jobs performed by such multi function printing apparatus.

### BACKGROUND OF THE INVENTION

As to printers connected to a communications network, printers performing various kinds of managements regarding print jobs have been conventionally proposed.

For example, a system where a printer is shared by a plurality of users via a communications network enables printing in response to a request for performing a print job from anyone who can connect to this network regardless whether he/she is an authorized user. In view of this, in such a system having a printer connected to a communications network, the printer preferably manages whether a person who requests it to perform a print job is an authorized user so that the printer can determine whether to permit printing of print data.

For example, patent document 1 (Japanese Laid-Open Patent Application No. 215373/2002; Tokukai 2002-215373 (published on Aug. 2, 2002)) discloses an image forming system including the following image forming device: Upon receipt of print data, it obtains print restrictions information of a host having transmitted the print data from a restriction address data storage server, using a transmitting-end physical address added to the print data, and determines whether to permit printing on the basis of the obtained print restrictions information.

However, in the system disclosed in the patent document 1, under the circumstances where a print count as print restrictions information is set for each host, when actual print count reaches the set print count, even a necessary print job is not allowed to perform. This makes it impossible to perform a necessary print job, resulting in interference with work.

Thus, the system disclosed in the patent document 1 has the problem that a necessary printing of print data is impossible since a print job restriction determined on a preset criteria cannot be changed appropriately when the necessity for the change arises.

Further, in a system where the preset print count is freely changeable so as to allow for a print job above the allowable print count, the following problem is caused. Namely, in this case, the preset print count setting a limit for the number of printable sheets becomes meaningless, and the number of printed sheets in a print job cannot be reduced. As such, the cost of print job cannot be reduced.

Further, in a system where the preset print count is changed by the system manager upon request from a host, the host user needs to request the manager to change the print count, and in doing so the user may need to present documents, etc. that explain the need to perform a print job for the print data. That is, in order to change the print count and perform a print job, the user needs to prepare such documents in making a request, and the print job cannot be carried out efficiently.

### SUMMARY OF THE INVENTION

The present invention was made in view of the foregoing problems, and an object of the invention is to provide a printing apparatus, a print control program, and a storage medium storing a print control program, in which print job restrictions (print restrictions) are set to reduce the cost of print job, and in which settings of the print restrictions can be changed as required.

In order to achieve the foregoing object, the present invention provides a printing apparatus in which print restrictions concerning print jobs are set for each user requesting the print jobs, the printing apparatus including: a change authorization confirming section for confirming whether a manager authorized to specify settings of the print restrictions authorizes changing information of the print restrictions as requested by the user, the printing apparatus performing a print job with the print restrictions information changed by the user, if the change authorization confirming section confirms that the manager has authorized to change the print restrictions.

The print restrictions information refers to information concerning restrictions of print jobs, set for each user carrying out a print job on the printing apparatus.

A printing apparatus according to the present invention is adapted to set print restrictions. Thus, for example, if print restrictions are set such that the user is allowed or disallowed to use the printing apparatus, only authorized users can perform print jobs.

Further, if the print restrictions set the number of printable sheets for each user, there will be no wasteful print job carried out by the user. That is, with a printing apparatus according to the present invention, the cost of print job can be reduced.

Further, with the change authorization confirming section, the printing apparatus can perform a print job according to the content of new print restrictions of the user, if the change authorization confirming section confirmed that the manager has authorized to change the information of print restrictions.

That is, in a printing apparatus according to the present invention, a print job can be carried out based on content of new print restrictions if the manager has authorized to do so. Thus, with an authorization of the manager, a necessary print job can be performed even when it is prevented by the print restrictions.

That is, the printing apparatus can suppress the manager from handing out authorization and therefore changing print restrictions unnecessarily, and can perform a print job by appropriately changing settings of print restrictions as required.

Further, with the change authorization confirming section provided in the printing apparatus, the user is not required to go to the manager and obtain authorization for changing print restrictions if he or she wishes to change the print restrictions set for the user. Instead, the user can quickly obtain authorization for changing print restrictions, and the efficiency of print job can be improved.

Thus, with a printing apparatus according to the present invention, the cost of print job can be reduced, and the print job can be efficiently performed by changing the print restrictions as required by the print job.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram schematically illustrating an exemplary structure of a multi function printer according to one embodiment of the present invention.

FIG. 2 is a diagram schematically illustrating an exemplary structure of a print management system according to one embodiment of the present invention.

FIG. 3 is a block diagram schematically illustrating an exemplary structure of a schedule management unit according to one embodiment of the present invention.

FIG. 4 is a diagram illustrating an example of a schedule file according to one embodiment of the present invention.

FIG. 5 is a diagram illustrating an example of displayed content of print data related to schedules of the schedule file according to one embodiment of the present invention.

FIG. 6 is a diagram illustrating a display example of schedules stored in the schedule management unit according to one embodiment of the present invention.

FIG. 7 is a diagram illustrating a display example of schedules on a specific date, in the schedules stored in the schedule management unit according to one embodiment of the present invention.

FIG. 8 is a diagram illustrating another display example of schedules on a specific data, in the schedules stored in the schedule management unit according to one embodiment of the present invention.

FIG. 9 is a flow chart of an exemplary print job performed by a multi function printer according to print job instructions of print data from a user terminal according to one embodiment of the present embodiment.

FIG. 10 is a flow chart of an exemplary print job performed by the multi function printer according to print data read out by the multi function printer according to one embodiment of the present invention.

FIG. 11 is a flow chart representing exemplary processing steps of the user terminal in performing a print job in the print management system according to one embodiment of the present invention.

FIG. 12 is a flow chart representing exemplary processing steps of the schedule management unit in performing a print job in the print management system according to one embodiment of the present invention.

FIG. 13 is a flow chart representing exemplary processing steps of the manager terminal in performing a print job in the print management system according to one embodiment of the present invention.

FIG. 14 is a flow chart of another exemplary print job performed based on print data read by the multi function printer according to one embodiment of the present invention.

FIG. 15 is a flow chart of an exemplary print job performed based on print data read by the multi function printer according to another embodiment of the present invention.

FIG. 16 is a flow chart of an exemplary print job performed based on print data read by the multi function printer according to still another embodiment of the present invention.

FIG. 17 is a flow chart of an exemplary print job performed based on print data read by the multi function printer according to another embodiment of the present invention.

FIG. 18 is a block diagram schematically illustrating an exemplary structure of a user terminal according to one embodiment of the present invention.

FIG. 19 is a block diagram schematically illustrating an exemplary structure of a multi function printer according to another embodiment of the present invention.

FIG. 20 is a diagram schematically illustrating a structure of a print management system according to another embodiment of the present invention.

### DESCRIPTION OF THE EMBODIMENTS

### First Embodiment

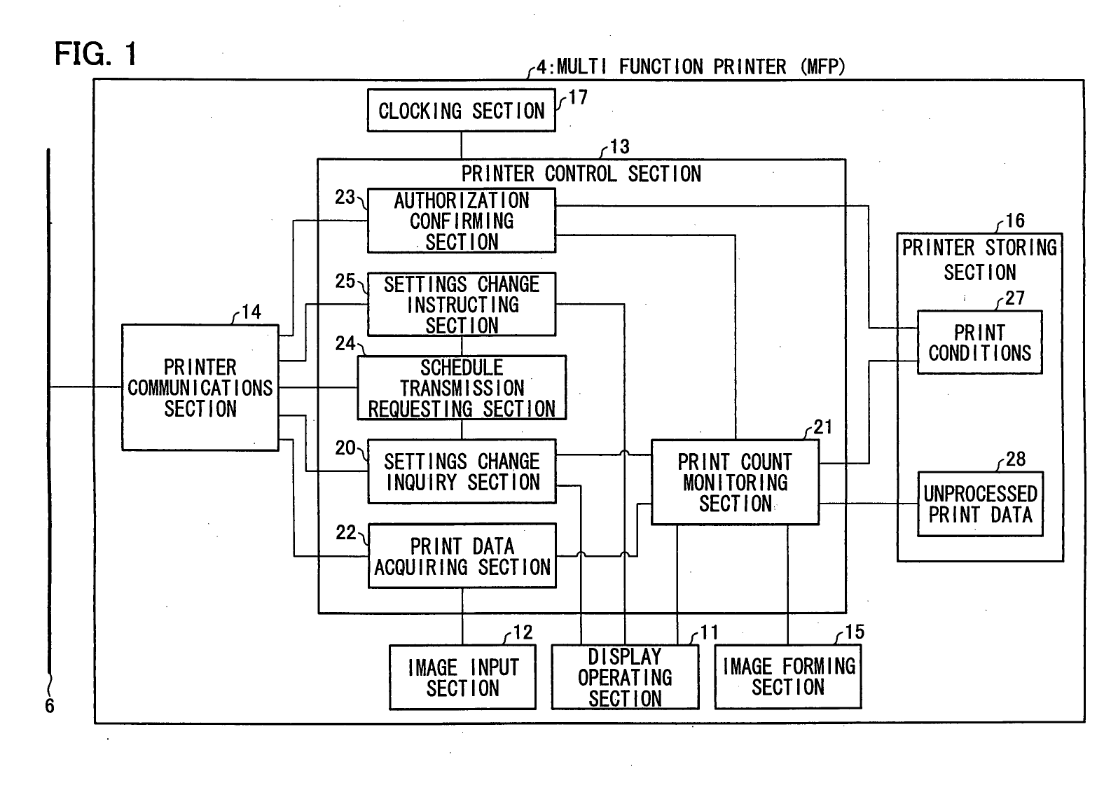

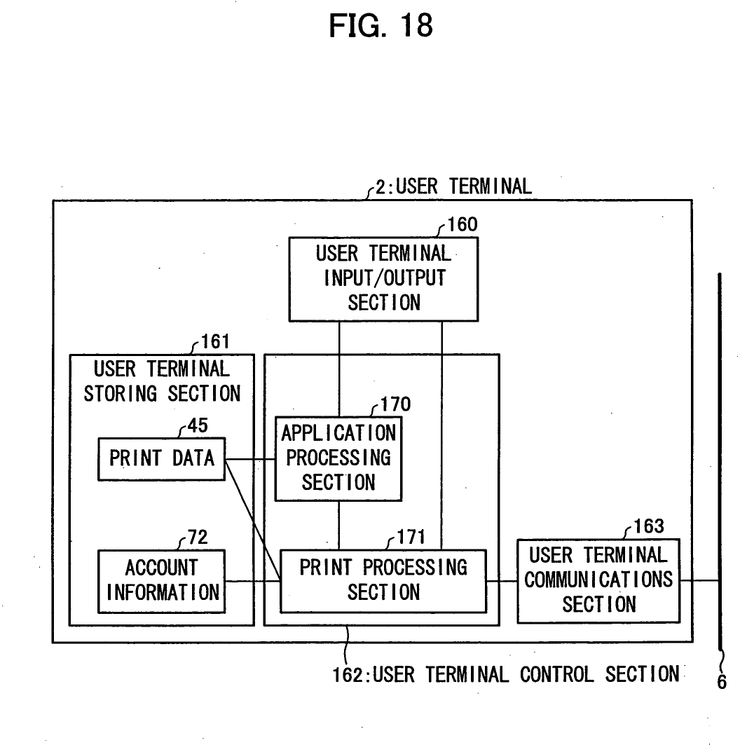

One embodiment of the present invention is described below with reference to FIG. 1 through FIG. 14, FIG. 17, and FIG. 18.

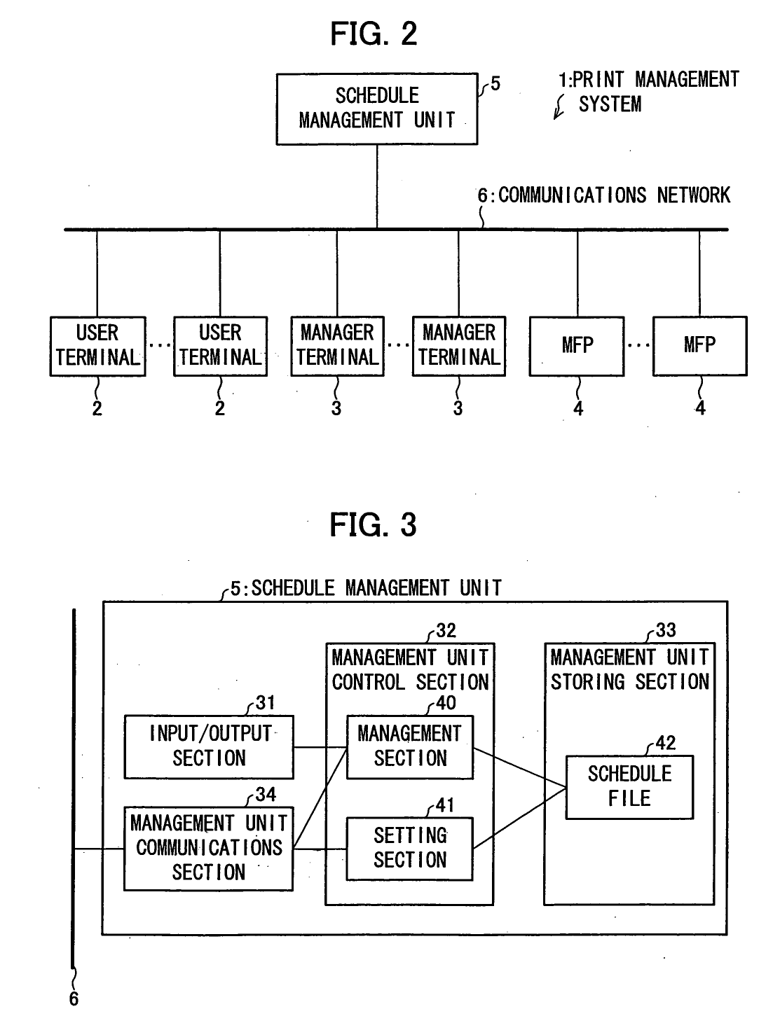

Referring to FIG. 2, the following will describe a schematic structure of a print management system 1 according to the present invention. It should be noted here that FIG. 2 merely schematizes an exemplary structure of the print management system 1.

As shown in FIG. 2, the print management system 1 includes one or more user terminals 2, one or more manager terminals 3, one or more multi-function printers (MFP) 4, and a schedule management unit 5, which are communicably connected to one another via a communications network 6.

The user terminal 2 creates print data 45 according to user instructions, and sends the print data 45 to the multi-function printer 4 to request a print job. In making a print job request to the multifunction printer 4, the user terminal 2 sends account information 72, which specifies a user operating the user terminal 2, for example.

Further, as will be described later, the user terminal 2 requests the schedule management unit 5 to send schedules concerning users operating the user terminal 2. The user terminal 2 also requests the manager terminal 3 to authorize (permit) changing the upper limit of print count allocated to the user.

The manager terminals 3 are used by managers who manage print jobs of users operating the user terminals 2 in the print management system 1.

Note that, the managers are authorized to set the upper limit of print count in the print management system 1, so that each user of the user terminals 2 can carry out a print job up to a certain number of sheets for example. In an analogy with a corporate organization, the managers are equivalent of management staff for example. A plurality of manager terminals 3 are provided in FIG. 2. However, the invention is not just limited to this example, and only one manager terminal 3 may be provided.

With the manager terminal 3 solely provided, the location of a manager operating the manager terminal 3 is readily identifiable. This enables the user terminal 2 to more easily set a destination of a request asking for permission to change the upper limit of print count, as compared with the case where more than one manager terminal 3 is provided.

In the case where the print management system 1 is provided with a plurality of manager terminals 3, requests from the user terminals 2 can be divided and processed by more than one manager terminal 3. This improves the efficiency of processing the requests from the user terminals 2, as compared with the case where requests from the user terminals 2 are all handled by a single manager terminal 3.

Note that, the manager terminal 3 has a hardware structure similar to those found in common computers. Namely, the manager terminal 3 includes a processing unit (CPU: central processing unit), a memory unit, and an interface unit serving as an external interface. Various operations of the manager terminal 3 are performed by causing the processing unit to run a program stored in the memory unit.

The multi function printers 4 are multi functional units with the functions of, for example, carrying out a print job based on the print data 45 sent from the user terminals 2 or read out in the multi function printers 4, and printing out data entered at an external facsimile apparatus (not shown) and transmitted through the communications network 6 or a phone line (not shown). As to a structure of the multi function printers 4, details will be described later.

The communications network 6 constitutes a communication path between the user terminals 2, the manager terminals 3, the multi function printers 4, and the schedule management unit 5. Known communications networks can be used as the communications network 6, including, for example, the Internet, LAN (Local Area Network), and designated lines.

The schedule management unit 5 manages the schedule of each user of the user terminals 2 provided in the print management system 1 of the present embodiment, or the schedules of predetermined groups of user terminals 2. The schedule management unit 5 sends schedule information it manages to the user terminals 2, the manager terminals 3, and the multi function printers 4 in response to requests independently made by these devices, so that the users can check the schedules at the user terminals 2, the manager terminals 3, and the multi function printers.

Note that, despite that the print management system 1 according to the present embodiment includes a sole schedule management unit 5, a plurality of schedule management units 5 may be provided as well. For example, in an environment where schedules are often managed on a department basis in an organization, it is preferable that the schedule management unit 5 be provided for each department, and that the schedule management units 5 be configured to exchange information so that the schedule information can be shared between the schedule management units 5.

Further, the schedule management units 5 may be adapted to include not only schedule information of the department they manage but also all schedule information including schedule information of other departments.

Providing the schedule management unit 5 for each department is advantageous in situations where a large number of departments are present and a print count needs to be managed in each department, because in this case schedules can be directly grasped in each department.

Further, in a print management system 1 provided with a plurality of schedule management units 5, the schedule management units 5 can spread the task, and there accordingly will be no overaccess to a particular schedule management unit 5.

Further, the schedule management unit 5 may be provided to serve as a back-up unit for stored data in the other schedule management units 5. In this case, malfunction, broken data, or other failure in one of the schedule management units 5 can be backed up by other schedule management units 5.

In the print management system 1 according to the present embodiment, each user has an allocated print count in the multi function printers 4. Thus, in the print management system 1, unnecessary print jobs carried out by each user or each group can be suppressed. This saves running cost and resources such as print sheet or toner.

Note that, the allocation of processable print sheets in the multi function printers 4 can be made not only on a user basis but also according to how the multi function printers 4 are used. For example, the allocation can be made based on units of departments made up of plural users, or units of teams made up of arbitrary users.

(Structure of User Terminal)

Referring to FIG. 18, the following will describe a structure of the user terminals 2. FIG. 18 is a block diagram schematically illustrating an exemplary structure of the user terminals 2.

As shown in FIG. 18, the user terminals 2 each include a user terminal input/output section 160, a user terminal storing section 161, a user terminal control section 162, and a user terminal communications section 163.

The user terminal input/output section 160 receives user instructions through an input section, and displays content of input instructions to users. Examples of the input section include a keyboard, numeric keys, a cursor key, a mouse or other types of pointing devices, and a touch panel. Examples of the output section include various types of displays such as an LCD (Liquid Crystal Display).

The user terminal communications section 163 enables information to be sent and received to and from the manager terminals 3, the multi function printers 4, and the schedule management unit 5 via the communications network 6. Specifically, according to instructions from the user terminal control section 162, the user terminal communications section 163 sends print data and therefore print job instructions to the multi function printer 4, or receives from the multi function printer 4 an inquiry concerning whether to change the upper limit of print count allocated to the user.

Further, the user terminal communications section 163 receives schedule information from the schedule management unit 5, or receives from the manager terminal 3 instructions concerning approval or non-approval of change of the upper limit of print count allocated to the user.

The user terminal storing section 161 can be realized by non-volatile memory, for example, such as a flash EEPROM (Electronically Erasable Programmable Read Only Memory), or a hard disk. The user terminal storing section 161 stores print data 45.

The user terminal control section 162 controls various parts of the user terminal 2. The user terminal control section 162 includes an application processing unit 170 and a print processing unit 171, which are provided as functional blocks.

The application processing unit 170 creates print data based on information entered by a user through the user terminal input/output section 160. The print data 4 so created is stored in the user terminal storing section 161.

According to instructions from the user terminal input/output section 160 or the application unit 170, the print processing unit 171 reads out stored print data in the user terminal storing section 161, and sends the print data or print job instructions to the multi function printer 4 via the user terminal communications section 163.

As to the processes carried out by the user terminal control section 162, more detail will be described later.

(Structure of Multi Function Printer)

Referring to FIG. 1, the following will describe a detailed structure of the multi function printers 4. FIG. 1 schematizes an exemplary structure of the multi function printers 4.

As shown in FIG. 1, the multi function printers 4 each include a display operating section (schedule selecting and outputting section) 11, an image input section 12, a printer control section 13, a printer communications section 14, an image forming section 15, a printer storing section (unprocessed print data storing section) 16, and a clock section (response time setting section) 17.

The display operating section 11 receives user instructions through an input section, and displays contents of user instructions to a user through an output section. Examples of the input section includes a key board, numeric keys, a cursor key, a mouse or other types of pointing devices, and a touch panel. Examples of the output section include various types of displays such as an LCD (Liquid Crystal Panel). Note that, the display operating section 11, together with the settings change inquiry section 20 (described later), realizes the schedule selecting and outputting section.

The image input section 12 is provided to fetch image in the form of print data 45, in order to copy the image for example. As used herein, the “image” includes figures, photographs, pictures, and characters.

The printer communications section 14 enables information to be sent and received to and from the user terminal 2, the manager terminal 3, and the schedule management unit 5 via the communications network 6. Specifically, the printer communications section 4 sends information indicative of the upper limit of print count to the user terminal 2 according to instructions sent from the printer control section 13, or receives from the user terminal 2 a request for expanding the upper limit of print count.

Further, the printer communications section 14 receives schedule information from the schedule management unit 5, or receives from the manager terminal 3 instructions concerning approval or non-approval of change of the upper limit of print count allocated to a user.

The image forming section 15 serves to print out an image on a print sheet according to print data 45 received through the printer communications section 14 or read out by the image input section 12. The printed sheet in the image forming section 15 is sent to a sheet ejection opening (not shown) and ejected therethrough.

The clock section 17 clocks and manages a response time of the manager terminals 3. Specifically, the multi function printer 4 is set so that, in requesting the manager terminal 3 to change the upper limit of print count allocated to a user making a print job request, no print job is carried out when the manager terminal 3 does not send a reply within a predetermined time period.

The clock section 17 constitutes a timer for measuring the predetermined time period. In the print management system 1, the clock section 17 can suitably set the duration of predetermined time period. With a suitable response time set for the manager terminal 3, a user requesting change of the upper limit of print count will not be put on hold indefinitely while the multi function printer 4 waits for a reply from the manager terminal 3.

A response time can be set for each manager terminal 3, taking into account activities of the manager operating the manager terminal 3.

The printer storing section 16 can be realized by non-volatile memory, for example, such as flash EEPROM (Electrically Erasable Programmable Read Only Memory), or a hard disk. The printer storing section 28 stores print conditions 27 (print restrictions information) and unprocessed print data 28. The printer storing section 16, together with a print count monitoring section 21 (described later) realizes the unprocessed print data storing section.

The print conditions 27 constitute relational information including (i) account information 72 for specifying a user or group using the user terminal 2 requesting a print job, (ii) an upper limit of print count allocated to the user or group, and (iii) print count history.

The unprocessed print data 28 constitute unprocessed data in the print data 45 received through the printer communications section 14, or read out by the image input section 12.

More specifically, when the print count exceeds the allocated upper limit during a print job performed by the multi function printer 4 according to the present embodiment, the user terminal 2 requests the manager terminal 3 to change the upper limit. The multi function printer 4 is set so that, while the request is being made, the suspended print data, i.e., the unprocessed print data 28, is stored in the printer storing section 16.

The printer control section 13 serves to control various parts of the multi function printer 4. The printer control section 13 includes various functional blocks, including a settings change inquiry section (change request confirming section, unprocessed print information notifying section, schedule selecting and outputting section) 20, a print count monitoring section (allocation determining section, print suspending section, print quantity notifying section) 21, a print data acquiring section 22, an authorization confirming section (change permit confirming section, print quantity notifying section, response time setting section) 23, a schedule transmission requesting section (print schedule acquiring section) 24, and a settings change instructing section (change permit confirming section) 25. These functional blocks can be realized, for example, by causing a CPU to run a program stored in a ROM (Read Only Memory) (not shown), by reading it from a RAM (Random Access Memory) (not shown).

The print data acquiring section 22 is provided to acquire the print data 45 read out by the image input section 12, or sent from the user terminal 2 through the printer communications section 14.

The print data acquiring section 22 sends the acquired print data 45 to the image forming section 15 via the print count monitoring section 21, and instructs the image forming section 15 to perform a print job based on the print data.

The print count monitoring section 21 (allocation determining section, print suspending section, print quantity notifying section) monitors whether the print count allocated to the user of the user terminal 2 requesting for printing of the print data 45 has reached the upper limit. While monitoring the print count whether it has reached the upper limit, the print count monitoring section 21 sends the print data 45, received from the print data acquiring section 22, to the image forming section 15. Further, while monitoring the print count whether it has reached the upper limit, the print count monitoring section 21 sends instructions for carrying out a print job based on the print data 45.

The print count monitoring section 21, together with the authorization confirming section 23, realizes the print quantity notifying section. Namely, in response to a print job carried out by the image forming section 15 based on the print data 45, the print count monitoring section 21 counts the number of printed sheets consumed in the print job. The result is sent to the schedule management unit 5 via the authorization confirming section 23.

Further, the print count monitoring section 21, when it determines that the print count has reached the upper limit, instructs the image forming section 15 to suspend the print job of the print data 45, and causes the printer storing section 16 to store the unprocessed print data 28 yet to be printed. Further, the print count monitoring section 21 notifies the settings change inquiry section 20 of the result, so as to ask the user whether to change the upper limit.

In response to instructions from the print count monitoring section 21, the settings change inquiry section 20 (change request confirming section) asks the user terminal 2 making a print job request whether to change the upper limit. In the case where the multi function printer 4 is carrying out a print job based on the print data 45 sent from the user terminal 2, the settings change inquiry section 20 sends the inquiry to the user terminal 2 via the printer communications section 14, so as to confirm whether the user is changing the upper limit. The settings change inquiry section 20, together with the print count monitoring section 21, realizes the unprocessed print information notifying section.

On the contrary, in the case where the print data 45 is read out by the image input section 12 as in copying, the settings change inquiry section 20 instructs the display operating section 11 to display an inquiry concerning whether to change the upper limit of print count.

From the display operating section 11 or the user terminal 2, the settings change inquiry section 20 receives a user reply to the inquiry concerning whether to change the upper limit of print count. When the user is changing the upper limit, the settings change inquiry section 20 instructs the schedule transmission requesting section 24 to acquire schedules of the user from the schedule management unit 5.

On the other hand, when the user is not changing the upper limit, the settings change inquiry section 20 instructs the print count monitoring section 21 to terminate the print job in the image forming section 15.

In response to the instructions from the settings change inquiry section 20, the schedule transmission requesting section 24 (print schedule acquiring section) requests the schedule management unit 5 to send schedules of the user making a print job request, so as to acquire the schedules.

Upon receiving the schedules from the schedule management unit 5, the schedule transmission requesting section 24 sends the schedules to the settings change instructing section 25, and instructs the settings change instructing section 25 to obtain authorization of the manager terminal 3 concerning the request for changing the upper limit of print count.

In response to the instructions form the schedule transmission requesting section 24, the settings change instructing section 25 sends the schedule to the manager terminal 3, and requests the manager terminal 3 to authorize changing the upper limit allocated to the user. The settings change instructing section 25, together with the authorization confirming section 23, realizes the change authorization confirming section.

In response to the request from the settings change instructing section 25, the authorization confirming section 23 receives instructions authorizing or not authorizing the request for changing the upper limit of print count. When the instructions received from the manager terminal 3 authorize the request for changing the upper limit, the authorization confirming section 23 accordingly rewrites the print conditions 27 allocated to the user of the user terminal 2 making a print job request.

Further, the authorization confirming section 23 instructs the print count monitoring section 21 to continue the print job in the image processing section 15. Note that, the authorization confirming section 23 can instruct the clock section 17 to set an arbitrary waiting time for a reply from the manager terminals 3 concerning permission to change. That is, the authorization confirming section 23, together with the clock section 17, realizes the response time setting section.

(Structure of Schedule Management Unit)

Referring to FIG. 3, the following will describe a detailed structure of the schedule management unit 5. FIG. 3 schematizes an exemplary structure of the schedule management unit 5.

The schedule management unit 5 serves to manage users or groups, such as departments or project teams, in the print management system 1. As shown in FIG. 3, the schedule management unit 5 includes an input/output section 31, a management unit control section 32, a management unit storing section 33, and a management unit communications section 34.

The input/output section 31, using an input section, creates input information of schedules at the initial settings and sends it to the management unit control section 32. Further, the input/output section 31, using an output section, receives output information from the management unit control section 32 and outputs it. Examples of the input section include a key board, numeric keys, a cursor key, a mouse or other pointing devices, and a touch panel. Examples of the output section include various types of displays such as an LCD (Liquid Crystal Display).

Note that, entry of schedule information is restricted by a preset password, so that only specific operators, i.e., managers, can make the entry. Alternatively, the schedule management unit 5 stores account information 72 of operators who are allowed to enter schedules, so that only specific operators with the account information 72 can enter schedule information.

In entering schedule information through the input/output section 31, a manager enters a password, or account information 72 identifying himself or herself in the schedule management unit 5. Based on the password or account information 72, a management section 40 determines whether or not to enter the schedule information. If the operator is an authorized user, the management section 40 receives the entered schedule, and writes and stores it as a schedule file 42 in the management unit storing section 33.

The management unit communications section 34 enables various data to be sent and received to and from the user terminals 2 and the multi function printers 4 via the communications network 6. Namely, the management unit communications section 34 converts the transmitted data into suitable form and sends it through the communications network 6. In receiving data, the management unit communications section 34 converts the data into suitable form for internal processing, and sends it to the management unit control section 32. The management unit communications section 34 can be realized by a modem, a terminal adapter, or a network adaptor, for example.

The management unit storing section 33 serves to store various information, and is realized by a semiconductor memory or hard disk, for example. In the schedule management unit 5 of the present embodiment, the management unit storing section 33 stores schedule file 42. The schedule file 42 will be described later in detail.

The management unit control section 32 serves to control various members of the schedule management unit 5 altogether. The management unit control section 32 includes the management section 40 and a setting section 41 as functional blocks. These functional blocks can be realized, for example, by causing a CPU to run a program stored in a ROM (Read Only Memory) (not shown) or the like, by reading it from a RAM (Random Access Memory) (not shown).

With the schedule information and the like entered through the input/output section 31, the setting section 41 determines whether the user who has entered the information is an authorized user. If the entry is made by an authorized user, the setting section 41 writes the entered schedule as the schedule file 42 in the management unit storing section 33.

Further, when a print job is performed in response to user instructions, the setting section 41 writes the number of printed sheets used in the schedule of the user.

Namely, by being notified from the multi function printer 4 that the print job has been finished and upon receipt of the resulting print count of the print job, the setting section 41 writes the print count in the user schedule.

(Schedule File)

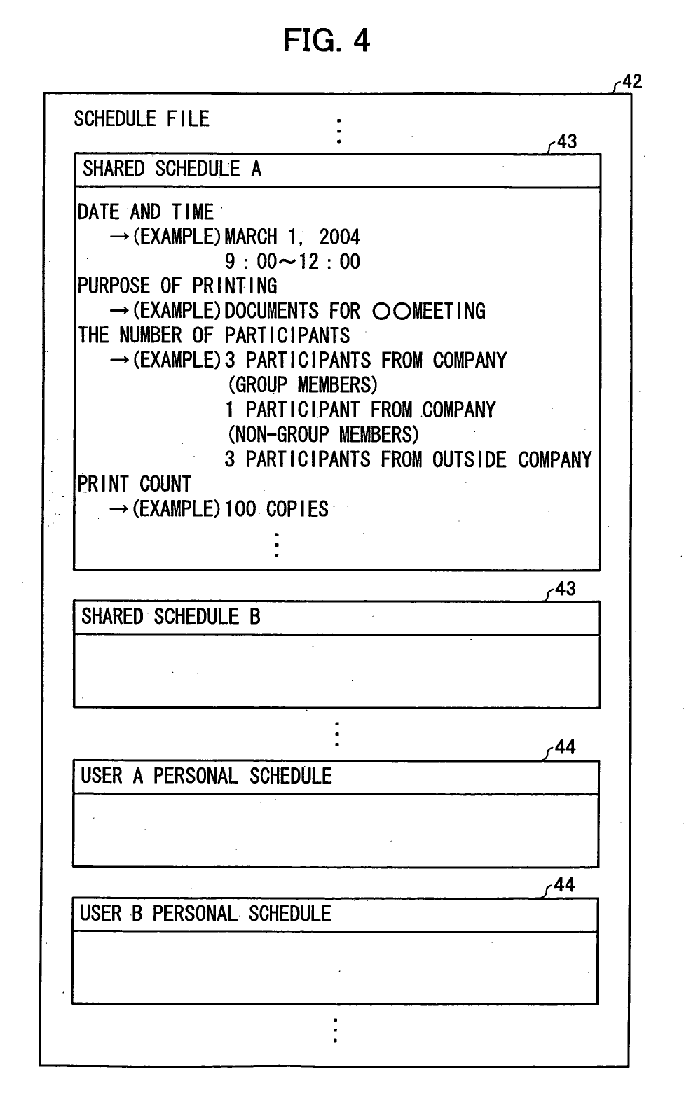

Referring to FIG. 4, the following will describe a schedule file 42 stored in the management unit storing section 33. FIG. 4 illustrates an exemplary schedule file according to the present embodiment.

As shown in FIG. 4, the schedule file 42 includes information of schedules being managed for each subject for which the number of printed sheets used in a print job is managed in the print management system 1. For example, the schedules include shared schedules 43 (shared schedule A, shared schedule B, . . . ), and user personal schedules (user A personal schedule, user B personal schedule, . . . ).

The shared schedules refer to schedules of departments or project teams, for example. The user personal schedules refer to schedules of individual users using the multi function printers 4.

The schedules managed in the schedule file 42 are not just limited to the shared schedules 43 and the user personal schedules 44. The schedule file 42 may manage these schedules by breaking them up according to the importance of the schedules in the work environment.

The shared schedules 43 and the user personal schedules 44 are related to account information 72 for specifying groups such as departments or project teams, or account information 72 for specifying individual users. This enables the schedule management unit 5 to select from the schedule file 42 schedules based on the account information 72 it receives.

Further, as to the shared schedules, users allowed to use the schedules may be set so that the shared schedules 43 can only be used by users having the account information 72.

The content of the shared schedules 43 and the user personal schedules 44 are stored by being related to information such as date and time, purpose of printing, and a required number of sheets, as shown in FIG. 4. Note that, the shared schedules are stored by also being related to information, for example, such as the number of participants in a meeting.

With the schedules stored in relation to information such as date and time, purpose of printing, a required number of sheets, and the number of participants, one can grasp when the print job will be made in what number and for what purpose.

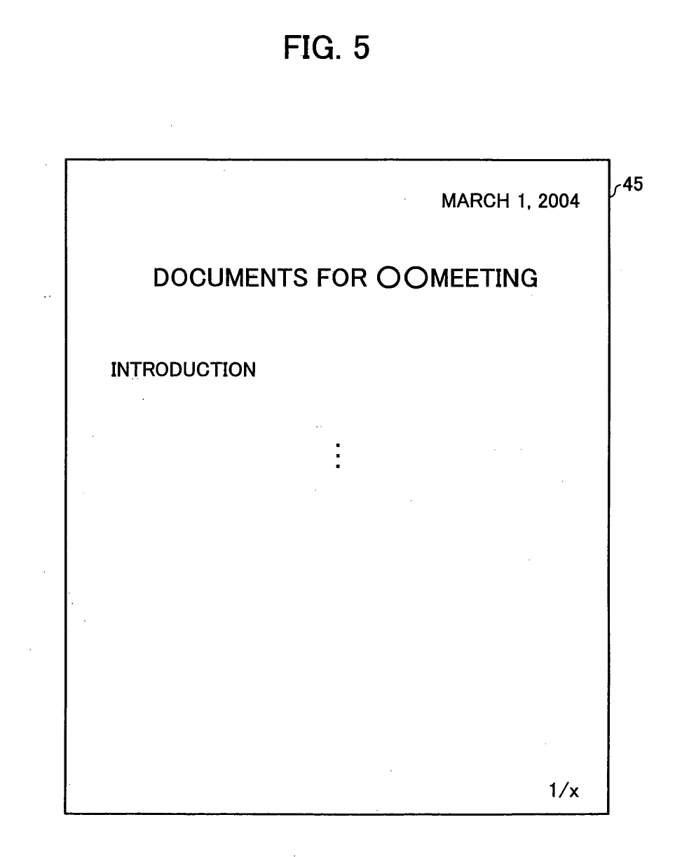

Further, the schedule content of the shared schedules 43 and the user personal schedules 44 are related to the print data 45. For example, the schedule content of shared schedule A is related to the print data 45 shown in FIG. 5. FIG. 5 illustrates an exemplary content of print data related to the schedule.

The schedule content and the print data 45 can be related to each other by relating the header information of the print data 45 to the schedule content. It should be noted however that the print data 45 can be related to the schedule content only when the print data 45 is in the form of electronic data sent from the user terminals 2. As such, the print data 45 cannot be related to the schedule content when it is obtained from a print sheet by being read out with the image input section 12 as in copying.

Thus, in copying (to be described later), schedule content corresponding to the print data 45 is selected in such a manner that the display operating section 11 displays schedules of users and thereby enables users to select schedule content corresponding to the print data 45.

Further, the number of printed sheets actually made in a print job actually performed for the purpose recorded in the schedules is written in the shared schedules 43 and the user personal schedules 44.

Thus, in the multi function printers 4 of the present embodiment, the difference between scheduled print count and actual print count can be known from the history of past schedules.

Thus, based on schedule history, the upper limit of print count can be suitably allocated to individual users or departments on a monthly or yearly basis, thereby budgeting based on an expected monthly or yearly print count.

(Print Job Instructed from User Terminals)

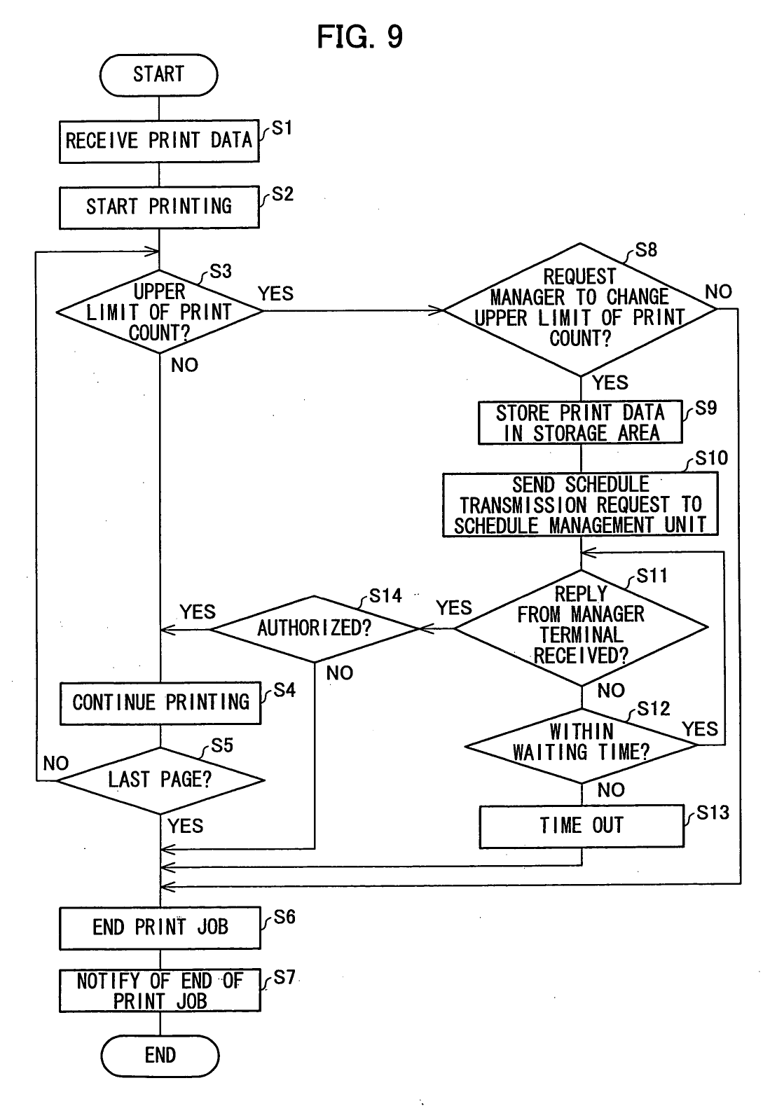

Referring to FIG. 9, the following will describe a print job performed by the multi function printer 4 in response to print instructions sent with the print data 45 from the user terminal 2 to the multi function printer 4. FIG. 9 is a flow chart of a process carried out by the multi function printer 4 in response to print instructions for the print data 45 sent from the user terminal 2.

The multi function printer 4 according to the present embodiment is adapted so that, when the print count based on the print data 45 during the print job reaches the upper limit of print count allocated to users, the multi function printer 4 requests the manager terminal 3 to change the upper limit of print count and thereby asks for continuation of the print job.

In the following, description is made as to how a print job is carried out based on the print data 45 sent from the user terminal 2, assuming that the user of the user terminal 2 has been allocated with a print count, i.e., an upper limit of print count.

First, from the user terminal 2, the multi function printer 4 receives the print data 45 and print job instructions for the print data 45 (step S1, hereinafter “step” will be abbreviated to “S”). In sending the print data 45 and print job instructions to the multi function printer 4, the user terminal 2 also sends account information 72 allocated to the user.

Specifically, from the user terminal 2, the print data acquiring section 22 in the multi function printer 4 receives the print data 45, print job instructions, and account information 72 via the communications network 6. In response to the print job instructions from the user terminal 2, the print data acquiring section 22 sends the print data 45 to the image forming section 15 via the print count monitoring section 21, so as to start a print job based on the received print data 45 (S2).

In the print job, the multi function printer 4 determines, based on the account information 72, whether the print count has reached the upper limit allocated to the user of the user terminal 2 from which the print data 45 has been sent (S3).

More specifically, in the multi function printer 4, the print count monitoring section 21, based on the account information 72 and referring to the print conditions 27 stored in the printer storing section 16, confirms the upper limit of print count allocated to the user terminal 2 from which the print data 45 has been sent. The print count monitoring section 21 then determines whether the print count has reached the upper limit while the print data 45 received from the print data acquiring section 22 is successively transferred to the image forming section 15.

If No in S3, i.e., if the print count monitoring section 21 determines that the print count has not reached the allocated upper limit during the print job carried out based on the print data 45, the print job based on the print data 45 is allowed to proceed (S4). The print job continues until the print count monitoring section 21 determines that the last page has been printed (“Yes” in S5).

If the print count of the print data 45 has reached the upper limit allocated to the user (“Yes” in S3), i.e., if the print count monitoring section 21 determines that the print count has reached the allocated upper limit during the print job, the print count monitoring section 21 makes an inquiry to the user terminals 2 whether to make a request for changing the upper limit of print count (S8).

That is, upon determining that the print count has reached the upper limit allocated to the user making a print job request, the print count monitoring section 21 notifies the settings change inquiry section 20 as such. In response, the settings change inquiry section 20 attaches thumbnail information to the information indicative of whether to make a request for changing the upper limit of print count to the user terminal 2 that has sent the print data 45, and sends these information via the printer communications section 14.

Note that, the thumbnail information is a graphical representation of unprocessed print data 28 in the form of a list, i.e., image data for displaying thumbnails. In this manner, with the thumbnail information, the multi function printer 4 can make an inquiry to the user terminal 2 whether to make a request for changing the upper limit. This enables the user to decide whether or not it is required to print the unprocessed print data 28.

The user terminal 2 which has sent the print data 45 can be specified by the account information 72 of the user of the user terminal 2, sent from the print count monitoring section 21 and received by the settings change inquiry section 20.

A reply of the user terminal 2 concerning the inquiry is received by the settings change inquiry section 20 via the printer communications section 14. The settings change inquiry section 20 confirms whether the reply requests for change of the upper limit of print count (S8).

If the settings change inquiry section 20 determines that the reply from the user terminal 2 requests for change of the upper limit (“Yes” in S8), the settings change inquiry section 20 sends instructions to the print count monitoring section 21 in order to store the unprocessed print data 28 of the print data 45 in the printer storing section 16. In response, the print count monitoring section 21 causes the printer storing section 16 to store the unprocessed print data 28 (S9).

Further, the settings change inquiry section 20 sends instructions to the schedule transmission requesting section 24 in order to obtain user schedules of the user terminals 2 from the schedule management unit 5. In sending the instructions, the settings change inquiry section 20 sends account information 72 of users of the user terminals 2 to the schedule transmission requesting section 24.

In response to the instructions from the settings change inquiry section 16, the schedule transmission requesting section 24 instructs the schedule management unit 5 to send schedules of the users using the user terminal 2 (S11).

In response to the instructions from the schedule transmission requesting section 24, the schedule management unit 5 selects from the schedule file 42 stored therein a schedule corresponding to the account information 72 it received, and sends the selected schedule to the user terminals 2.

From the schedule information, the user terminal 2 selects a schedule corresponding to the print data 45 being printed, and requests the manager terminals 3 to change the upper limit of print count.

Upon receipt of the request for changing the upper limit of print count sent from the user terminals 2, the manager terminals 3 sends a reply to the multi function printers 4.

Details of processes performed by the user terminal 2 and the schedule management unit 5 will be described later.

Once a request has been sent to the schedule management unit 5 in S10 as to transmission of schedules, the multi function printer 4 is put on hold until the manager terminal 3 replies the request for changing the upper limit of print count sent from the user terminal 2.

Specifically, in the multi function printer 4, the authorization confirming section 23 determines whether a reply from the manager terminal 3 has been received (S11). If Yes, the authorization confirming section 23 determines whether the reply authorizes changing the upper limit of print count (S14).

If the authorization confirming section 23 determines that the reply from the manager terminal 3 authorizes changing the upper limit of print count (Yes in S14), the authorization confirming section 23 instructs the print count monitoring section 21 to continue printing the unprocessed print data 28 which has been suspended.

In response to the instructions from the authorization confirming section 23, the print count monitoring section 21 reads out the unprocessed print data 28 stored in the printer storing section 16, and sends it to the image forming section 15 for a print job. In response, the image forming section 15 starts a print job based on the unprocessed print data 28 (S4).

The print job is performed for the entire print data 45, i.e., until the last page of the print data 45 is printed. The print job in the multi function printer 4 is finished when the process is finished for the entire print data 45 (S6).

On the contrary, if the authorization confirming section 23 determines that a reply from the manager sections 3 has not been received (No in S11), it is determined whether a response time has been passed (S12). Specifically, the multi function printers 4 according to the present embodiment set a response time for the manager terminals 3, and the clock section 17 measures the response time.

In the present embodiment, when the schedule transmission requesting section 24 requests the schedule management unit 5 to send schedules, a signal is sent to the clock section 17 in order to clock a predetermined time period from the receipt of the signal. When a predetermined time period has passed, the clock section 17 notifies the authorization confirming section 23 that a predetermined time period has been passed. In response, the authorization confirming section 23 determines that a reply from the manager terminals 3 was not received within the predetermined time period, and instructs the print count monitoring section 21 to stop the print job as being time out (S13).

Note that, the system may be adapted so that, when the user terminal 2 in receipt of schedules from the schedule management unit 5 asks for authorization of the manager terminals 3 as to change of the upper limit of print count, the user terminal 2 notifies the multi function printer 4 that a request for authorization has been made, and that the clock section 17 starts clocking a predetermined response time upon receiving such a request.

When the print job of the print data 45 is finished, the multi function printer 4 notifies the user terminal 2 and the schedule management unit 5 that the print job has been finished (S7). Together, the user terminal 2 in S7 sends information concerning the number of printed sheets to the schedule management unit 5.

The unprocessed print data 28 stored in the printer storing section 16 is automatically deleted when a reply from the manager terminal 3 is not received by the multi function printer 4 within a predetermined time period, or when the manager terminal 3 does not authorize changing the upper limit of print count. That is, by being instructed from the authorization confirming section 23 to stop the print job, the print count monitoring section 21 deletes the unprocessed print data 28 stored in the printer storing section 16.

(Print Job in Copying)

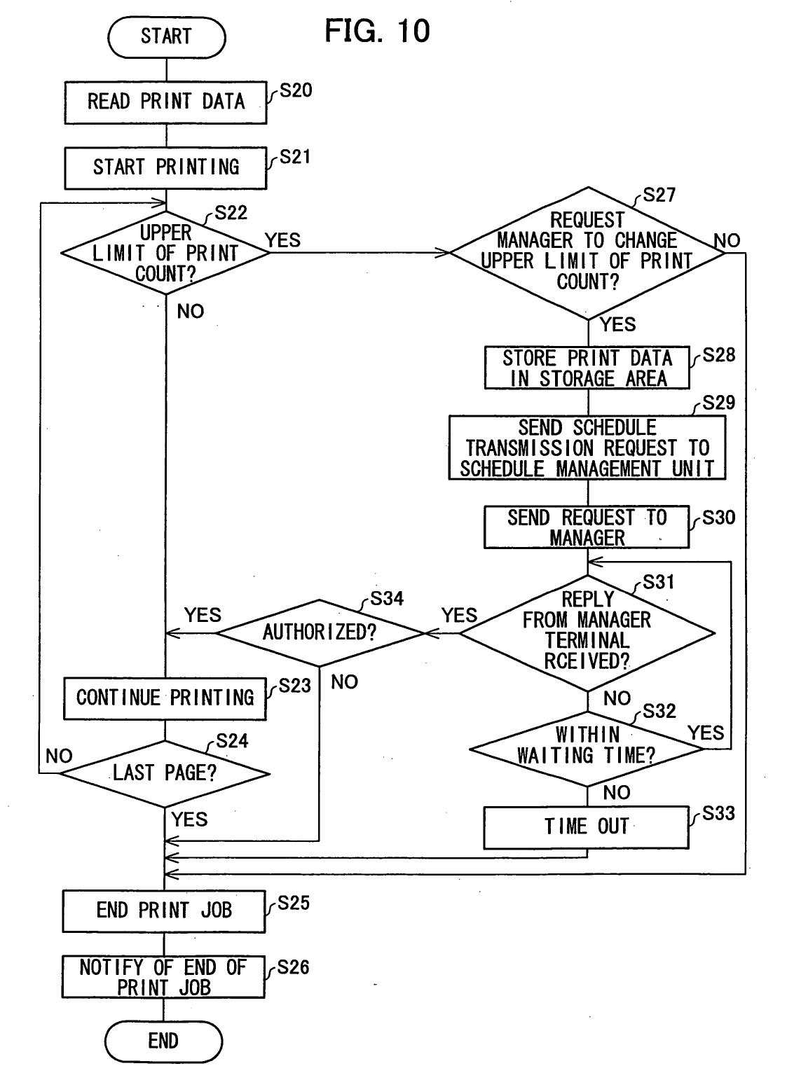

Referring to FIG. 10, the following will describe the case where the print data 45 is read by the image input section 12 of the multi function printer 4 as in copying. FIG. 10 is a flow chart of a print job carried out based on print data 45 read out in the multi function printer 4.

As shown in FIG. 10, first, the image input section 12 of the multi function printer 4 reads out print data 45 from a document being printed by a user (S20).

In entering a print document in the multi function printer 4, the user also enters account information 72 identifying himself or herself. With the account information 72 entered by the user, the multi function printer 4 can confirm the upper limit of print count allocated to the user who has entered the print document.

The information entered in the multi function printer 4 by the user is not limited to the account information 72, and may be any information as long as it corresponds to the account information 72 sent to the multi function printer 4 when the user of the user terminal 2 enters the print data 45 in the multi function printer 4.

Upon receipt of the print document with the account information 72 identifying the user, the multi function printer 4 starts printing based on the print data 45 of the entered print document (S21). Specifically, in the multi function printer 4, the image input section 12 reads out print data 45 from the print document entered by the user, and the print data 45 is transferred to the print data acquiring section 22. The print data acquiring section 22 sends the print data 45 to the image forming section 15 via the print count monitoring section 21, and the image forming section 15 starts a print job based on the print data 45.

As to the subsequent processes of the print job, no explanation will be made since these processes, i.e., S22 through S26 are the same as S3 through S7 described above with reference to FIG. 9.

If the print count during the print job started in S21 reaches the allocated upper limit of the user requesting the print job (Yes in S22), the multi function printer 4 makes an inquiry to the user whether to request the manager to change the upper limit of print count (S27). Specifically, if it is determined during the print job that the print count has reached the allocated upper limit of the user requesting the print job, the print count monitoring section 21 notifies the settings change inquiry section 20 as such.

By being notified by the print count monitoring section 21, the settings change inquiry section 20 instructs the display operating section 11 to make an inquiry to the user whether to make a request for changing the upper limit of print count.

In response to the instructions from the settings change inquiry section 20, the display operating section 11 displays an inquiry, for example on a display section, concerning whether to change the upper limit of print count. Note that, the inquiry is displayed with the unprocessed print data 28 in the form of thumbnails. This enables the user to easily grasp content of the unprocessed print data 28.

In receiving the print data 45, the print data acquiring section 22 can determine whether the print data 45 has been sent from an external user terminal 2 via the printer communications section 14, or entered through the image input section 12.

Thus, depending on the result obtained in the print data acquiring section 22, the settings change inquiry section 20 can decide whether to instruct the user to make a request through the print communications section 14, or display an inquiry in the display operating section 11.

With the display operating section 11 displaying an inquiry whether to make a request for changing the upper limit of print count, the user decides whether to make such a request, using the input section, such as a touch panel, provided in the display operating section 11. If the user decides not to make a request for changing the upper limit (No in S27), the multi function printer 4 finishes the print job when the upper limit is reached (S25).

On the contrary, if the user decides to request the manager to change the upper limit of print count (Yes in S27), the settings change inquiry section 20 of the multi function printer 4 sends instructions to the print count monitoring section 21 so as to store the unprocessed print data 28 in the printer storing section 16. In response to the instructions from the settings change inquiry section 20, the print count monitoring section 21 instructs the printer storing section 16 to store the unprocessed print data 28 (S28).

Further, the settings change inquiry section 20 instructs the schedule transmission requesting section 24 to make a request for transmission of schedules concerning the user requesting the print job. In response, the schedule transmission requesting section 24 via the printer communications section 14 instructs the schedule management unit 5 to send schedules of the user (S29).

The user schedules transmitted from the schedule management unit 5 in response to the instructions from the schedule transmission requesting section 24 is received by the schedule transmission requesting section 24. The schedule transmission requesting section 24 then instructs the display operating section 11 to display the schedules.

With the display operating section 11 displaying the schedules sent from the schedule transmission requesting section 24, the user operates a touch panel etc. of the display operating section 11 to select schedules corresponding to the print data 45 being printed, from among the schedules displayed in the display operating section 11. The user then makes a request for changing the allocated upper limit of print count.

The schedules requested and selected by the user are sent to the settings change instructing section 25. In response, the settings change instructing section 25 sends the transmitted schedules of the user to the manager terminals 3, and makes a request for changing the allocated upper limit of print count (S30). Note that, no explanation will be made for the processes of S31 through S34 since these processes are the same as those of S12 through 14 described above with reference to FIG. 9. However, as to the response time of the manager terminal 3, the response time may be a predetermined elapsed time period from the time the settings change instructing section 25 requests the manager terminal 3 to change the upper limit of print count, instead of the elapsed time period from the time the schedule transmission requesting section 24 requests the schedule management unit 5 to send schedules.

In this case, the settings change instructing section 25 sends a signal to the clock section 17 when requesting the manager terminal 3 to change the upper limit of print count. Upon receipt of the transmitted signal, the clock section 17 clocks a predetermined time period, and notifies the authorization confirming section 23 when the predetermined time period has passed.

(Processing Steps of the User Terminal in a Print Job)

The foregoing described processing steps of the multi function printer 4 in a print job, based on the case where the print data 45 is entered through the user terminals 2, and the case where the print data 45 is entered through the image input section 12 by being read out.

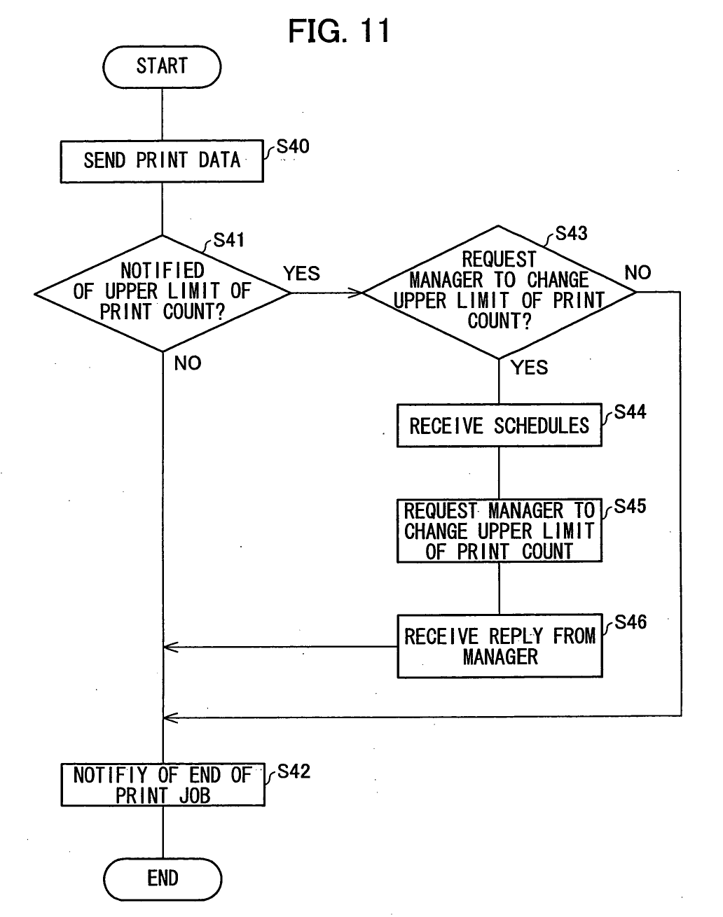

Referring to FIG. 11, the following will describe processing steps of the user terminal 2 in a print job. FIG. 11 is a flow chart of processing steps of the user terminal 2 in a print job. Note that, the processes of these steps are performed by the user terminal control section 162.

First, in order to print the print data 45 residing in the user terminal 2, the user terminal 2 sends the print data 45 to the multi function printer 4 (S40). Here, in the user terminal 2, the print processing section 171 reads out the print data 45 from the user terminal storing section 161, and the print data 45 is sent to the multi function printer 4 with the account information identifying the user of the user terminal 2.

In printing the print data 45, the multi function printer 4 stops the print job, when the last page is printed before the upper limit of print count allocated to the user is reached (if No in S41). The multi function printer 4 then notifies the user terminal 2 that the print job has been finished (S42).

On the contrary, if the allocated upper limit of print count is reached during the print job, the multi function printer 4 notifies the user terminal 2 that the upper limit has been reached (Yes in S41). The user terminal 2 then receives an inquiry from the multi function printer 4 whether to change the upper limit of print count.

The inquiry from the multi function printer 4 is attached with data that enables the unprocessed print data 28 to be displayed in thumbnails. By referring to the thumbnail display of the unprocessed print data 28, the user can easily grasp the content of the unprocessed print data 28.

If the user does not want to change the upper limit of print count in response to the inquiry from the multi function printer 4 (No in S43), the user terminal 2 instructs the multi function printer 4 to stop the print job. In response, the multi function printer 4 notifies the user terminal 2 that the print job has been finished, and the user terminal 2 ends the print job (S42).

Note that, the multi function printer 4 notifies the user terminal 2 of the end of print job with the information that indicates that the print job of the print data 45 is incomplete. With the information, the user terminal 2 confirms that the print job was finished before all the print data 45 has been printed.

On the contrary, if the user wants to change the upper limit of print count in response to the inquiry from the multi function printer 4 (Yes in S43), the user terminal 2 instructs the multi function printer 4 to change the upper limit. Note that, the instructions from the user terminal 2 are made by the user through an external input section provided in the user terminal 2.

According to the user instructions requesting for change of the upper limit, the user terminal 2 instructs the schedule management unit 5 to send schedules of the user of the user terminal 2. In response, the schedule management unit 5 sends the schedules to the user terminal 2.

Note that, the transmission request of schedules may be made directly to the schedule management unit 5 from the user terminal 2, or via the multi function printer 4. In the case where the transmission request of schedules is directly made to the schedule management unit 5 from the user terminal 2, the printer control section 13 of the user terminal 2 is not required to be provided with the schedule transmission requesting section 24. This simplifies the structure of the user terminal 2.

Further, with the user terminal 2 sending the transmission request of schedules to the schedule management unit 5, the multi function printer 4 will know that the transmission request of schedule is being sent to the schedule management unit 5 from the user terminal 2.

Namely, the multi function printer 4 can monitor the operations performed by the user terminal 2 and the schedule management unit 5 in the print management system 1.

Preferably, the request for changing the upper limit of print count, made by the user terminal 2 to the manager terminal 3, is sent with data that enables the unprocessed print data 28 to be displayed in thumbnails.

By thus making a request for changing the upper limit of print count to the manager terminal 3 with data displayable in thumbnails, the manager operating the manager terminal 3 can grasp the content of the unprocessed data 28. Thus, by referring to the transmitted schedules, the manager can readily decide how the allocated upper limit of the user should be changed.

Upon receipt of the schedules from the schedule management unit 5 (S44), the user terminal 2 instructs the output section such as a display device to display the schedules.

Preferably, the schedules are displayed in such a manner that the current schedules being printed are easily selected. This can be carried out, for example, by not displaying the past schedules.

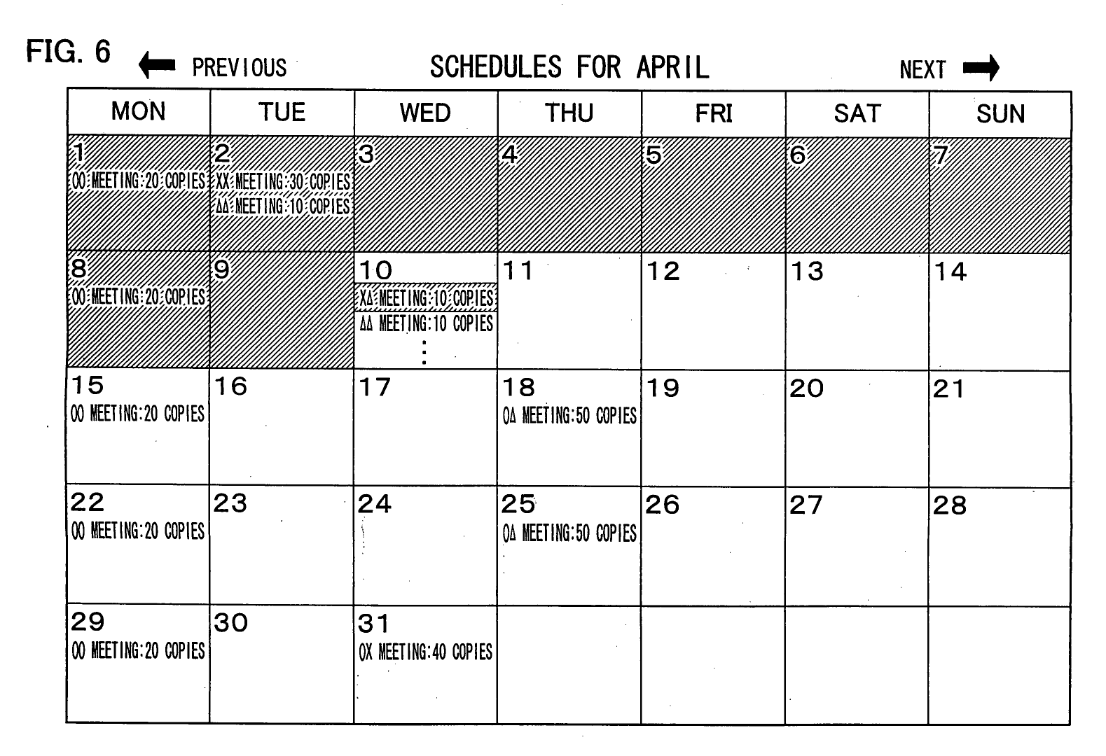

More specifically, user schedules of April are displayed in the manner illustrated in FIG. 6, for example. FIG. 6 shows exemplary displayed schedules held by the schedule management unit 5 according to the present embodiment.

In the schedules illustrated in FIG. 6, it is assumed that a user is requesting for copying print data 45 concerning the “xΔ meeting, 10 copies” in the April 10 cell.

Here, as shown in FIG. 6, the past schedules in the April 1-9 cells are hatched and cannot be selected by the user.

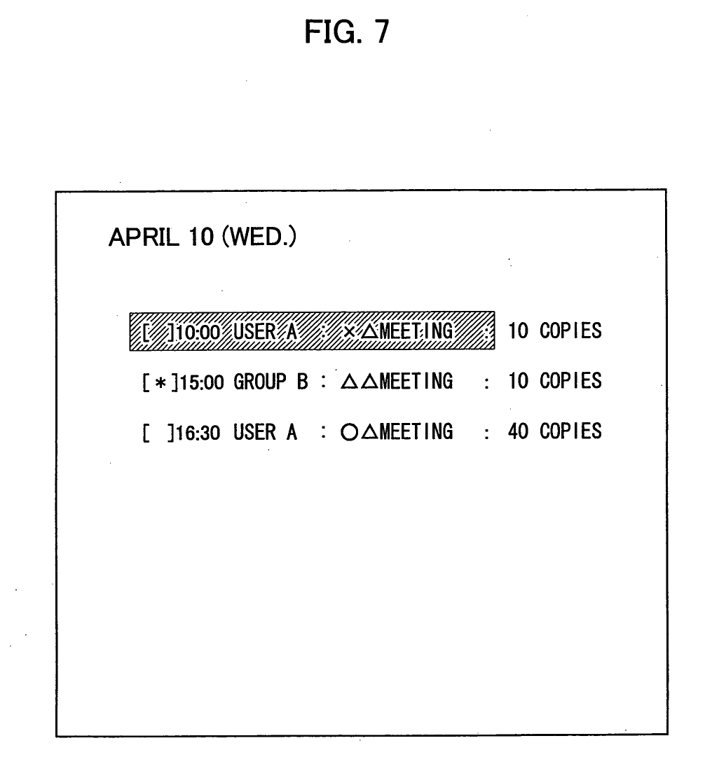

When the user selects the April 10 cell in the schedules of FIG. 6 using the display operating section 11, an enlarged view of the schedules for April 10 is displayed by the output section, such as a display device, in the display operating section 11, as shown in FIG. 7. FIG. 7 illustrates exemplary displayed schedules of a specific date.

When more than one print job is scheduled on the same day, a user is allowed to select a schedule through the input section, such as a touch panel, provided in the display operating section 11. In the present embodiment, the user schedules for April 10 include a xΔ meeting, a group ΔΔ meeting participated by the user, and a OA meeting. Here, since the schedule concerning print data for which copies are to be made by the user is the xΔ meeting, the user selects the xΔ meeting through the input section of the display operating section 11.

Note that, in making a selection, the user is prevented from selecting a print job for the group AA meeting if it has been printed already and thus appended with an asterisk as shown in FIG. 7.

Further, with the unprocessed print data 28 displayed together in thumbnails, the user can confirm the content of the unprocessed print data 28, for which change of the upper limit of print count needs to be requested to the manager terminal 3.

The foregoing described processes by which the user terminal 2 sends the print data to the multi function printer 4 for a print job. In these processes, in the case where the user receives schedules from the schedule management unit 5, the schedules are also displayed in the input/output section 160 of the user terminal 2 so as to allow the user to select a schedule concerning the print data. In addition, the system may be adapted to assist the user in selecting a schedule.

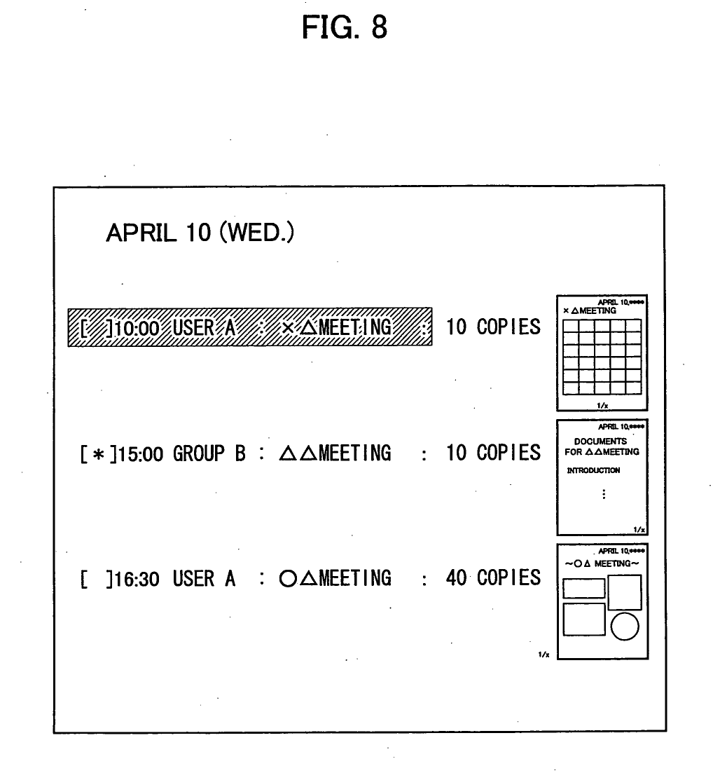

Further, in order to help the user confirm the content of the unprocessed print data 28, the system may be adapted so that the unprocessed print data 28 is displayed in thumbnails along with the content of the schedules, as shown in FIG. 8. FIG. 8 illustrates another example of displayed schedules of a specific date.

By referring to the displayed schedules, the user selects a schedule corresponding to the printed data 45 being printed, using the input section such as a keyboard. The user then enters instructions in the user terminal 2 through the input section, so as to request the manager terminal 3 to change the upper limit of print count. In response, the user terminal 2 sends a request for changing the upper limit of print count to the manager terminal 3, together with the schedule selected by the user (S45).

Note that, the request for changing the upper limit of print count may be sent to the manager terminal 3 either directly from the user terminal 2 or via the multi function printer 4. In the case where the request for changing the upper limit of print count is directly sent to the manager terminal 3 from the user terminal 2, the printer control section 13 of the user terminal 2 is not required to be provided with the settings change instructing section 25. This simplifies the structure of the user terminal 2.

Further, with the user terminal 2 and the schedule management unit 5 always sending and receiving instructions via the multi function printer 4 as in the case of sending a request for changing the upper limit of print count from the user terminal 2 to the manager terminal 3, the multi function printer 4 can grasp the results of operations performed by the user terminal 2 and the schedule management unit 5. Specifically, the multi function printer 4 can monitor the operations performed by the user terminal 2 and the schedule management unit 5 in the schedule management system 1.

Preferably, the request for changing the upper limit of print count sent from the user terminal 2 to the manager terminal 3 is made with the thumbnail display of the entire unprocessed print data 28 or print data 45.

By thus attaching thumbnails in requesting the manager terminal 3 to authorize changing the upper limit of print count, the manager of the manager terminal 3 can easily grasp the content of print data 45 being printed in the multi function printer 4, or the content of unprocessed print data 28 to be processed. The managers are therefore able to readily decide how to change the allocated upper limit of print count, by referring to the transmitted schedules.

Upon receiving a request for authorizing change of the upper limit of print count from the user terminal 2, the manager terminal 3 sends information concerning authorization of request, both to the user terminal 2 and the multi function printer 4. In S46, the user terminal 2 receives a reply of the manager terminal 3 concerning authorization.

Note that, the reply of the manager terminal 3 to the user terminal 2 includes information authorizing or not authorizing change of the upper limit of print count, and information indicative of, for example, new upper limit, or reasons for unauthorization.

Note that, the notification from the manager can be sent to the user terminal 2 by associating it with user schedule information held in the schedule management unit 5, using known PIM (Personal Information Management) software applicable to, for example, schedules, addresses, and mail.

Further, the reasons for unauthorization may be given by predefined template messages in the manager terminal 3, and may be selected by the manager of the manager terminal 3 to be sent to the user terminal 2. The information indicative of authorization or unauthorization of change of the upper limit of print count, sent from the manager terminal 3 to the multi function printer 4, includes information indicative of new upper limit of print count. According to this information, the authorization confirming section 23 in the multi function printer 4 rewrites the upper limit of print count corresponding to the account information 72 of user stored in the printer storing section 16.

With the manager terminal 3 authorizing change of the upper limit of print count, the multi function printer 4 continues the print job, and, when the print job is finished, notifies the user terminal 2 that the print job has been finished. On the contrary, if the reply from the manager terminal 3 does not authorize changing the upper limit of print count, or the reply is not received within a predetermined time period set in the multi function printers 4, the multi function printer 4 finishes the print job and sends a notification to the user terminal 2 that the print job has been finished before all the print data 45 was printed.

In S42, the user terminal 2 receives the notification from the multi function printer 4.

(Processing Steps of the Schedule Management Unit in a Print Job)

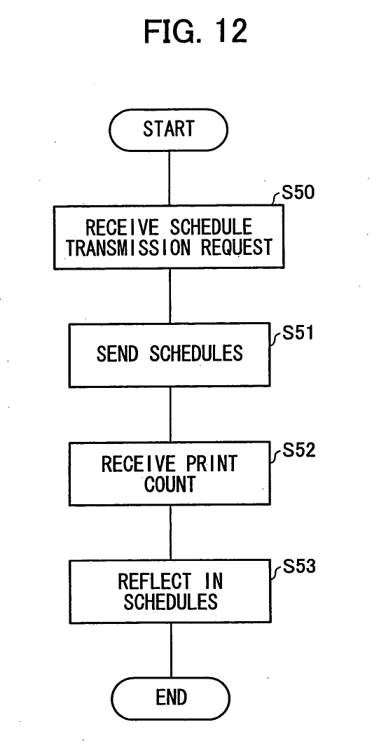

Referring to FIG. 12, the following will describe processing steps of the schedule management unit 5 in a print job. FIG. 12 is a flow chart of processing steps carried out in the schedule management unit 5 in a print job.

First, in S50, the schedule management unit 5 receives from the multi function printer 4 a schedule transmission request made by a user requesting a print job. Here, the schedule transmission request is received with the account information 72 for specifying the user. More specifically, the schedule transmission request and the account information 72 from the multi function printer 4 are received by the management unit communications section 34 of the schedule management unit 5 via the communications network 6.

The management unit communications section 34 then sends the schedule transmission request and the account information 72 to the management section 40.

In the case where the print management system 1 is configured so that the schedule transmission request is directly made by the user terminals 2, the schedule management unit 5 receives the schedule transmission request from the user terminal 2. In this case, the management unit communications section 34 receives the schedule transmission request and the account information 72 from the user terminal 2.

In response, the schedule management unit 5 selects schedule information of the user from the schedules stored therein, by referring to the account information 72 of the user. The schedule management unit 5 then sends the selected schedule to the multi function printer 4 (S51).

Namely, based on the account information 72 received via the management unit communications section 34, the management section 40 refers to the schedule file 42 stored in the management unit storing section 33 and selects therefrom a schedule corresponding to the account information 72. The management section 40 then sends the selected schedule to the multi function printer 4 via the management unit communications section 34.

In the case where the print management system 1 is configured so that the schedule is directly sent to the user terminal 2 without being sent to the multi function printer 4, the selected schedule is sent to the user terminal 2. In this case, the schedule selected from the schedule file 42 stored in the management unit storing section 33 is sent to the user terminal 2 from the management section 40.

Following the transmission of the schedule to the user terminal 2, the user terminal 2 requests the manager terminal 3 to authorize changing the upper limit of print count, and the multi function printer 4 finishes the print job of the print data 45. In this case, from the multi function printer 4, the schedule management unit 5 receives the schedule of the user who has requested the print job, and the number of printed sheets made in the print job (S52).

Upon receipt of the user schedule and the number of printed sheets, the schedule management unit 5 writes the print count in the schedule (S53). The schedule reflecting the number of printed sheets made in the print job is stored in the schedule management unit storing section 33.

Namely, in the schedule management unit 5, the setting section 41 receives the schedule and the number of printed sheets via the management unit communications section 34. The setting section then writes the number of printed sheets in the schedule, so as to update the schedule corresponding to the account information 72 of the user and stored in the management unit storing section 33.

In the print management system 1 of the present embodiment, the print conditions 27 stored in the multi function printer 4 are relational information including (i) account information 72 of each user, (ii) the upper limit of print count allocated to a user, and (iii) allowable print count reflecting the number of printed sheets made in a print job.

Thus, in the case where the print management system 1 includes a plurality of multi function printers 4, the schedule management unit 5 sends to each multi function printer 4 information regarding change of the allocated print count of the user, and information regarding the number of remaining sheets.

(Processing Steps of the Manager Terminals in a Print Job)

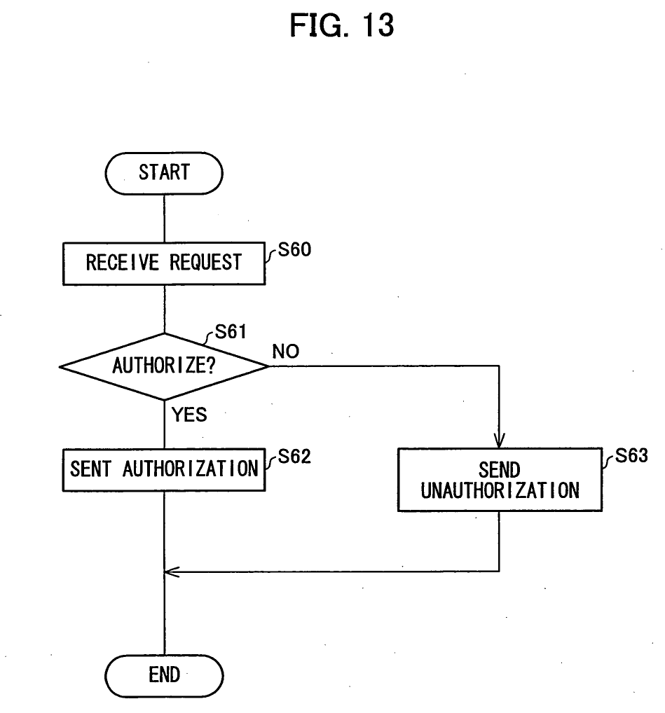

Referring to FIG. 13, the following will describe processing steps of the manager terminal 3 in the print management system 1 according to the present embodiment. FIG. 13 is a flow chart of processing steps of the manager terminal 3 in a print job.

First, assume that the print count during a print job has reached the allocated upper limit of the user operating the user terminal 2, and that the user terminal 2 sends schedules of the user to the manager terminal 3 together with a request for changing the upper limit of print count. In the case of copying, the following assumes that the multi function printer 4 sends user schedules to the manager terminal 3 together with a request for changing the upper limit of print count.

From the user terminal 2 or multi function printer 4, the manager terminal 3 receives schedules and a request for changing the upper limit of print count (S60). The manager terminal 3 then asks the manager of the manager terminal 3 whether to authorize the request (S61).

Specifically, upon receipt of schedules and a request for changing the upper limit of print count, the manager terminal 3 displays the received request and schedules on the output section such as a display device. By referring to the displayed schedules, the manager decides whether to authorize the request for changing the upper limit of print count sent from the user terminal 2.

Together with the request for changing the upper limit of print count sent from the user terminal 2, the manager terminal 3 also receives data for displaying unprocessed print data 28 (unprocessed portion of print data 45) in thumbnails. By referring to the thumbnail display, the manager can confirm the unprocessed print data 28 (unprocessed portion of print data 45), making it possible to immediately grasp the importance of unprocessed data.

For example, the manager confirms the received schedules and the thumbnail information of the unprocessed print data 28, and authorizes changing the upper limit of print count if the unprocessed print data 28 is decided to be important. If, on the other hand, the manager decides that the unprocessed print data do not require further printing, no authorization is given.

Further, by confirming the schedules, the manager can grasp the number of sheets required for printing and suitably change the upper limit of print count allocated to the user.

In the manner described above, in the case where the manager refers to the schedules and thumbnail information received by the manager terminal 3 and authorizes changing the upper limit of print count allocated to the user requesting the print job (Yes in S61), the manager terminal 3 notifies the multi function printer 4 that the request has been authorized (S62). Note that, the information sent from the manager terminal 3 includes information concerning a new upper limit of print count.

In the case where the print job is carried out based on print data 45 sent from the user terminal 2, the manager terminal 3 sends the information not only to the multi function printer 4 but to the user terminal 2 as well. This enables the user of the user terminal 2 to know that the request for changing the upper limit of print count has been authorized by the manager. The user will also know the new upper limit of print count currently allocated.

On the other hand, if the manager does not authorize changing the upper limit of print count allocated to the user requesting the print job (No in S61), the multi function printer 4 and the user terminal 2 are notified as such. Preferably, the user terminal 2 is notified with a message containing reasons for unauthorization, for example. By receiving and confirming the message, the user of the user terminal 2 will know the reasons for unauthorization.

As described above, with the print count monitoring section 21 provided in the multi function printer 4 of the print monitoring system 1 according to the present embodiment, the history of user print count can be monitored.

Thus, with the upper limit of print count allocated to each user, the multi function printer 4 will not carry out a print job exceeding the allocated upper limit. Thus, the users or groups will not perform print jobs unnecessarily, and there according will be no wasted sheets or toner.

Further, with the settings change inquiry section 20, the multi function printer 4 can confirm whether the user wants to change the upper limit of print count. Thus, when the print count reaches the allocated upper limit of user, the multi function printer 4 can confirm whether the user wants to continue a print job for the unprocessed print data 28.

Further, with the schedule transmission requesting section 24 and the settings change instructing section 25, the multi function printer 4 obtains schedules of the user from the schedule management unit 5, and sends the schedules to the manager, together with a request for changing the upper limit of print count.

Thus, even when the print count reaches the allocated upper limit, the user is not required to send his or her schedule and request the manager to change the upper limit.

Further, with the authorization confirming section 23, the multi function printer 4 can confirm the manager's reply concerning authorization for changing the upper limit, and decide whether to continue the print job according to the manager's reply.

Thus, in the print management system 1 according to the present embodiment, there will be no unnecessary print job, and a print job can be continued beyond the allocated upper limit of user if the manager authorizes a print job for the unprocessed print data 28. Further, since the user can send schedules to the manager terminal 3 from the user terminal 2 or the multi function printer 4 together with a request for changing the upper limit of print count, the user is not required to present schedules to the manager, in order to obtain authorization of the manager to change the upper limit of print count.

Further, in the print management system 1 according to the present embodiment, the multi function printer 4 can temporarily store the unprocessed print data 28 in the printer storing section 16. Thus, for example, the multi function printer 4 can carry out a print job for other print data, if any, while a request for changing the upper limit of print data is being made to the manager terminal 3. That is, the multi function printer 4 is always available for a print job.

The foregoing described the case where the print count reaches the allocated upper limit of the user while the print job instructed by the user is being performed.

However, the print management section 1 according to the present embodiment is not just limited to such an arrangement, and may be adapted so that an expected print count of a print job to be performed based on the print data 45 is calculated beforehand when the print data 45 is received or read out by the multi function printer 4. Further, in this case, the user may be asked whether to request the manager terminal 3 to change the upper limit of print count before starting a print job.

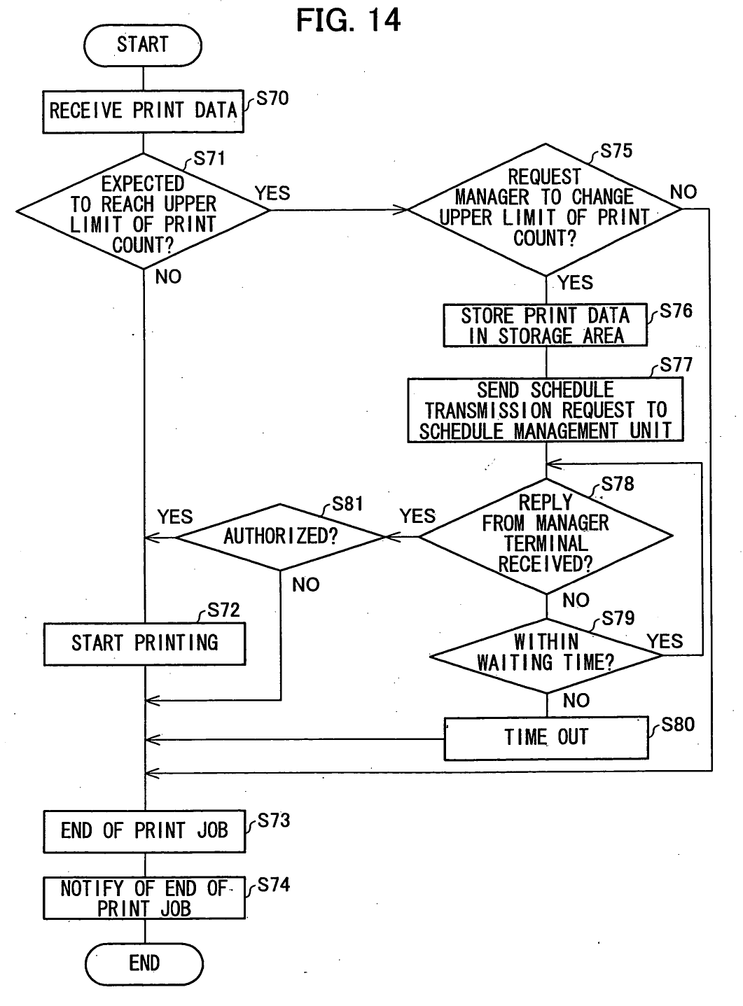

Specifically, as shown in FIG. 14, the multi function printer 4 receives the print data 45 from the user terminal 2 (S70). That is, upon receipt of the print data 45 from the user terminal 2 via the communications network 6, the print data acquiring section 12 sends the print data 45 to the print count monitoring section 21. FIG. 14 is a flow chart representing another example of a print job carried out based on the print data 45 read out by the multi function printer 4.

The print count monitoring section 21 calculates an expected print count of the print data 45 based on the number of copies to be made from the print data 45 as instructed by the user, or volume of the print data 45. Further, the print count monitoring section 21 checks the print conditions 27 to confirm an allowable print count left for the user, by referring to the account information 72 of the user sent with the print data 45.

The print count monitoring section 21 then compares the calculated print count with the allowable print count, so as to make a prediction for a print job to be carried out based on the entire print data 45. That is, the print count monitoring section 21 determines whether the calculated print count will exceed the allowable print count, i.e., whether the print count will reach the upper limit (S71).

If it is determined that the expected print count in the print job of the print data 45 will not exceed the allocated upper limit of the user (No in S71), a print job is started based on the print data 45 received from the user terminal 2 (S72). The processes of S73 and S74 are the same as those of S25 and S26 described with reference to FIG. 10, and no explanation will be made for these steps.

If, on the other hand, the print count monitoring section 21 determines that the print count will reach the upper limit (Yes in S71), the print count monitoring section 21 sends instructions to the settings change inquiry section 20, so as to ask the user terminal 2 whether to change the upper limit of print count. In response, the settings change inquiry section 20 makes an inquiry to the user terminal 2, and receives a user reply from the user terminal 2.

If the user reply from the user terminal 2 does not request the manager terminal 3 to change the upper limit of print count (No in S75), the settings change inquiry section 20 finishes the print job (S73).

If, on the other hand, the user reply from the user terminal 2 requests the manager terminal 3 to change the upper limit of print count (Yes in S75), the settings change inquiry section 20 sends instructions to the print count monitoring section 28 so as to cause the printer storing section 16 to store the print data 45, i.e., unprocessed print data 28, received by the print data acquiring section 22 from the user terminal 2.

According to the instructions from the settings change inquiry section 20, the print count monitoring section 21 stores the unprocessed print data 28 in the printer storing section 16 (S76). The print count monitoring section 20 then sends instructions to the schedule transmission requesting section 24 so that schedules of the user requesting a print job are sent to the user terminal 2 from the schedule management unit 5. In response, the schedule transmission requesting section 24 instructs the schedule management unit 5 to send the schedules to the user terminal 2. The processes of S78 through S81 are the same as those of S11 through S14 described with reference to FIG. 9, and no explanation will be made therefor.

It should be noted, however, that the process flow shown in FIG. 9 differs from that of FIG. 9 in the following respect. Specifically, contrary to S14 of FIG. 9, in S81 of FIG. 14, the print job of the print data 45 is started when the reply from the manager terminal 3 concerning the request for changing the upper limit of print count sent from the user terminal 2 authorizes the request (when Yes in S81).

Further, the print management system 1 according to the present embodiment is not limited to the configuration in which the schedule transmission request is made by the multi function printer 4 to the schedule management unit 5. Instead, the request may be made by the user terminal 2 to the schedule management unit 5. In this case, the multi function printer 4 is not required to carry out the process of S77, but the process is carried out by the user terminal 2. This simplifies the processes carried out by the multi function printer 4.

In S79 of FIG. 14, the multi function printer 4 has a preset waiting time for the manager terminal 3 to send a reply concerning authorization of changing the upper limit of print count. If a reply from the manager terminals 3 is not received within a specific time period (Yes in S79), the print job is finished.

The multi function printer 4 may be adapted to carry out another print job if it is requested during the waiting time.

As described above, in the print management system 1 according to the present embodiment, an expected print count of the print data 45 to be printed is confirmed before carrying out the print job, and whether or not the expected print count will exceed the allocated upper limit of user is determined. If the print count is expected to exceed the upper limit, it is preferable that a request be sent to the manager to change the upper limit.

The foregoing described the case where the print data 45 sent from the user terminal 2 is received by the multi function printer 4. However, the same can be said also for the case the print data 45 of a print document is read out by the image input section 12. That is, the print job can be started after confirming whether the print count will exceed the upper limit. FIG. 17 is a flow chart representing an exemplary print job carried out based on the print data 45 read out by the multi function printers 51.

Specifically, a user enters a password or account information 72 in the multi function printer 4, and the multi function printer 4 identifies the user. Then, according to user instructions for reading the print data 45, the image input section 12 reads the print data 45 (S130). The print data 45 is stored as unprocessed print data 28 in the printer storing section 16.

Based on the print data 45 so read out and user instructions concerning the number of copies to be made, the print count monitoring section 21 of the multi function printer 4 determines whether the print count expected in the copying process instructed by the user will reach the allocated upper limit of user. If it is determined that the expected print count in the copying process will not reach the upper limit (No in S131), the print count monitoring section 21 starts a print job based on the print data 45 read out (S132). The processes of S132 through S134 are the same as those in S73 and S74 of the process flow shown in FIG. 14, and no explanation will be made therefor.

On the other hand, if it is determined that the expected print count will exceed the allocated upper limit in the copying process (Yes in S131), the print count monitoring section 21 in the multi function printer 4 asks the user terminal 2 whether to request the manager to change the upper limit of print count (S135).

Namely, if the print count monitoring section 21 determines that the print count will exceed the upper limit allocated to the user instructing the copying process, the print count monitoring section 21 notifies the settings change inquiry section 20 as such. In response, the settings change inquiry section 20 instructs the display operating section 11 to display an inquiry concerning whether to request the manager to change the upper limit of print count. According to the instructions from the settings change inquiry section 20, the display operating section 11 displays an inquiry to the user and awaits a user reply.

If the user reply does not request the manager to change the upper limit of print count (No in S135), the multi function printer 4 ends the print job (S133).

If, on the other hand, the user reply requests the manager to change the upper limit of print count (Yes in S135), the unprocessed print data 28 read out by the image input section 12 is stored in the printer storing section 16 (S136).

Namely, with the user entering a reply in the input section of the display operating section 16, the information contained in the reply is sent to the settings change inquiry section 20 via the printer communications section 14. The settings change inquiry section 20 then analyzes the information received from the user terminal 2, and sends instructions to the print count monitoring section 21.

If the user reply from the user terminal 2 does not request the manager to change the upper limit of print count, the print count monitoring section 20, according to the instructions of the settings change inquiry section 21, instructs the image forming section 15 to end the print job, and the print job is finished.

If, on the other hand, the user reply requests the manager to change the upper limit of print count, the print count monitoring section 21, according to the instructions from the settings change inquiry section 20, causes the printer storing section 16 to store the unprocessed print data 28 read out by the image input section 12. The print count monitoring section 21 then sends instructions to the schedule transmission requesting section 24, so that schedules of the user instructing the copying process are sent to the multi function printer 4 from the schedule management unit 5 (S137).

The schedules transmitted from the schedule management unit 5 are received by the schedule transmission requesting section 24 via the printer communications section 14. The schedule transmission requesting section 24 causes the display operating section 11 to display the schedules, so as to allow the user to select a schedule whose content corresponds to the print data 45 for which copying is requested.

From the displayed schedules on the display operating section 11, the user selects a schedule whose content corresponds to the print data 45, using the input section of the display operating section 11. The schedule selected by the user is forwarded to the schedule transmission requesting section 24.

Note that, the schedules sent from the schedule management unit 5 have been sorted into processed data and unprocessed data, so that the unprocessed schedules will not be selected by the user. Further, the display operating section 11 displays the schedules with thumbnails of the print data 45.

By thus displaying the print data 45 in thumbnails, the user is allowed to easily grasp the content of the print data 45 and select a schedule.

The schedule management unit 5 forwards the schedule selected by the user to the settings change instructing section 25, and instructs the settings change instructing section 25 to make a request to the manager terminals 3 that the allocated upper limit of the user be changed (S138).

Note that, in requesting the manager terminal 3 to change the upper limit, the settings change instructing section 25 also sends the received schedules. The processes of S139 through S142 shown in FIG. 17 are the same as those in S78 through S81 described with reference to FIG. 14, and no explanation will be made therefor.

As described above, the print management system 1 according to the present embodiment may be adapted to determine beforehand whether an expected print count of the print job to be carried out based on the print data 45 will reach the allocated upper limit of user, and decides whether to start or stop the print job.

With this configuration, in the print management system 1 according to the present embodiment, when the print count for the instructed print job is expected to exceed the allocated upper limit of the user, a request for changing the upper limit of print count can be made to the manager terminal. The user is therefore able to quickly request the manager to change the upper limit of print count.

This is advantageous over the configuration in which a user instructing a print job requests the managers to change the allocated upper limit of the user when the print count reaches the upper limit during the print job, because, since the request is made prior to the print job, there will be no waste prints even when the manager does not authorize the request for changing the upper limit of print count.

Note that, as described above, the multi function printer 4 is set so that the print job is finished when the manager terminal 3 does not send a reply within a waiting time in the processing steps of FIG. 9 and FIG. 10 (S13 in FIG. 9, S33 in FIG. 10). However, the multi function printer 4 is not just limited to such a configuration, and may be set so that the print job is carried out beyond the allocated upper limit of user, by issuing temporary authorization. In this way, the user will not be interrupted while waiting for a manager's reply to the requested print job.

Further, as described above, with the account information 72 sent from the user terminals 2 or entered by the user performing copying, the multi function printer 4 confirms the upper limit of print count allocated to the user instructing the print job, based on the account information 72 and by referring to the print conditions 27. Further, the new upper limit of print count authorized by the manager terminal 2, and the number of sheets used in the print job are sent to the user terminals 2 and the schedule management unit 5 from the multi function printers 4 after the print job.

The schedule management unit 5 then updates the schedule file 42 so as to reflect the new upper limit of print count, and the number of sheets used in the print job.

In the case where a plurality of multi function printers 4 are provided, the new upper limit and the number of printed sheets used in the print job are sent not only to the multi function printer 4 that has performed the print job but also to the other multi function printers 4 as well, so as to update the print conditions 27 stored in the printer storing sections 16 of the multi function printers 4.

The print conditions 27 may be stored in the schedule management unit 5, instead of being stored in each multi function printer 4. In this case, with the account information 72 received from the user terminal 2, etc., the multi function printers 4 make an inquiry to the schedule management unit 5 as to the allocated upper limit of the user who has instructed the print job.

According to this configuration, in the case where the manager terminal 3 authorizes the request for changing the upper limit of print count and changes the upper limit, the upper limit is updated not by the multi function printer 4 but by the schedule management unit 5.

Namely, with the manager terminal 3 authorizing the request for changing the upper limit of print count sent from the user, and the new upper limit set, the multi function printer 4 notifies the schedule management unit about the number of printed sheets used in the print job, and the new upper limit. With the notice received by the schedule management unit 5, the manager terminal 3 changes the upper limit corresponding to the account information 72 of the user who has requested the print job, so as to manage the number of printable sheets left for the user by reflecting the number of consumed sheets.

Managing the print conditions 27 in the schedule management unit 5 is advantageous because, in this case, the information concerning the number of printed sheets used in the print job does not need to be sent to the multi function printer 4 and the manager terminals 3 after the print job.

It should be noted that the components and the process steps of the multi function printer 4 of the foregoing embodiment are realized by a CPU or other computing section executing a program stored in a ROM (Read Only Memory), RAM, or other storage device to control an input section such as keyboard and touch panel, an output section such as display, or communications section such as interface circuit. Therefore, a computer having these components can realize various functions and various processes in the multi function printer 4 of the present embodiment only by reading a storage medium storing the program and executing the program. Further, storage of the program into a removable storage medium realizes implementation of the same functions and processes on any computer.

The storage medium may be a memory (not shown) for process steps on a microcomputer. For example, the program medium may be something like a ROM. Alternatively, the program medium may be such that a program reader device (not shown) as an external storage device may be provided in which a storage medium is inserted for reading.

In addition, in any case, the stored program is preferably executable on access by a microprocessor. Further, it is preferred if the program is retrieved, and the retrieved program is downloaded to a program storage area in a microcomputer to execute the program. The download program is stored in a main body device in advance.

In addition, the program medium may be a storage medium constructed separably from a main body. The medium may be tapes, such as a magnetic tape or cassette tape; discs, such as a flexible disc or hard disk including a magnetic disc and CD/MO/MD/DVD; cards, such as an IC card (including a memory card); or a semiconductor memory, such as a mask ROM, EPROM (Erasable Programmable Read Only Memory), EEPROM (Electrically Erasable Programmable Read Only Memory), and a flash ROM. All these types of media hold the program in a fixed manner.

In contrast, the system is arranged to connect to the communications network 6 including the Internet, so that the medium is preferably a storage medium which holds the program in a flowing manner so that the program can be downloaded over the communications network 6.

Further, if the program is downloaded over the communications network 6 in this manner, it is preferred if the download program is either stored in a main body device in advance or installed from another storage medium.

Further, the print management system 1 according to the present embodiment may be arranged such that under circumstances where it is provided with a plurality of manager terminals 3, priorities are assigned to the manager terminals 3 so that the multi function printer 4 can make a request for changing an upper limit of print count allocated to a user, first to the manager terminal 3 with a higher priority.

Still further, the foregoing print management system 1 may be arranged such that if a manager of the manager terminal 3 to which the multi function printer 4 makes the request is absent, the same request from the multi function printer 4 is transferred to another manager terminal 3 automatically by priorities.

Alternatively, the foregoing print management system 1 may be arranged such that if a manager of the manager terminal 3 to which the multi function printer 4 makes the request is absent, the same request is automatically transferred to a portable terminal device (not shown) that the manager owns so that the manager makes a response indicative of approval or disapproval to the multi function printer 4, using the portable terminal device.

Further, the foregoing print management system 1 may be arranged such that the multi function printer 4 determines whether to make the request to the manager terminal 3 after obtaining a schedule of a manager of the manager terminal 3 from the schedule management server 5 to check whether the manager is present. Alternatively, the foregoing print management system 1 may be arranged such that under circumstances where it is provided with a plurality of manager terminals 3, the multi function printer 4 obtains all schedules of managers operating the manager terminals 3 so that the multi function printer 4 can transmit the request to the manager terminal 3 a manager of which is present.

### Second Embodiment

The foregoing described the print management system 1 in which a manager is requested to change the allocated print count upper limit of each user or group when the print count in a print job exceed the upper limit.

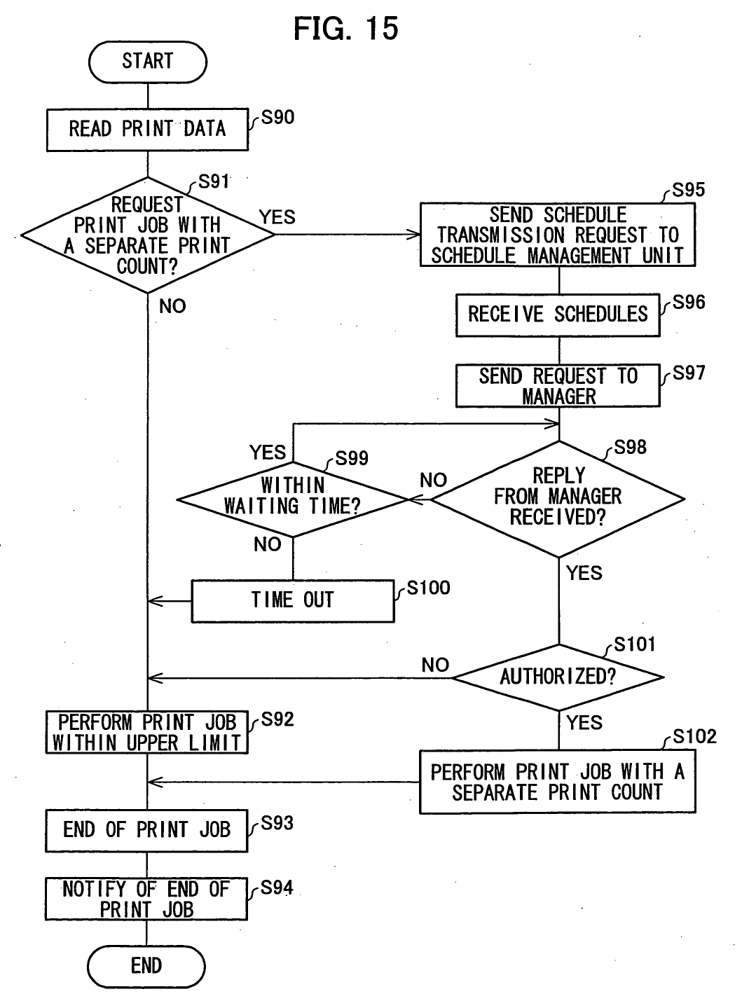

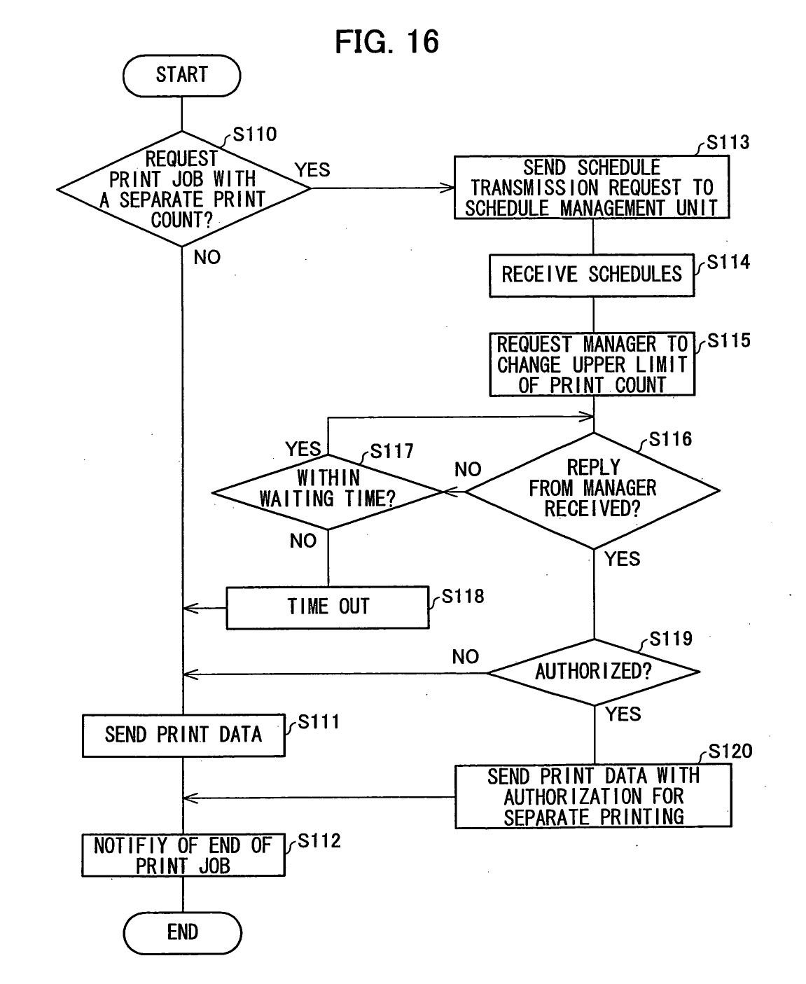

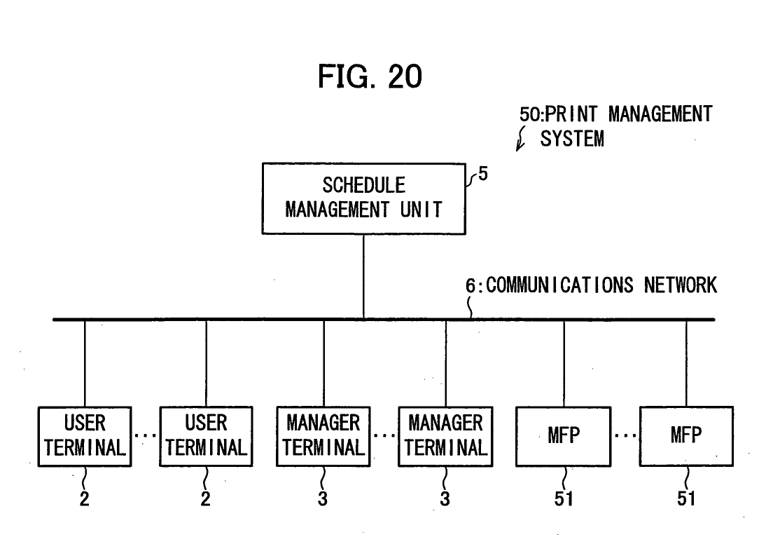

Referring to FIGS. 15, 16, 19, and 20, the following will describe another embodiment of the present invention. Namely, in the Second Embodiment, description is made as to a print management system 50, as shown in FIG. 20, in which users are allowed to choose whether to perform a print job using a print count allocated to each user, or perform a print job using a print count separately provided from the allocated print count, using a multi function printer 51.

Note that, the print count separately provided from the allocated print count of each user may be, for example, a spare print count additionally provided from the allocated print count of each user, or a print count allocated to a group of plural users.

As with the print management system 1 described above, the print management system 1 includes more than one user terminal 2, more than one manager terminal 3, more than one multi function printer (MFP) 51, and more than one schedule management unit 5.

The print management system 50 differs from the print management system 1 of the First Embodiment in the structure of the multi function printer 51. As such, the following description deals with only the structure of the multi function printer 51. Note that, constituting elements having the same functions as those described in the First Embodiment are given the same reference numerals and explanations thereof are omitted here.

(Structure of Multi Function Printer)

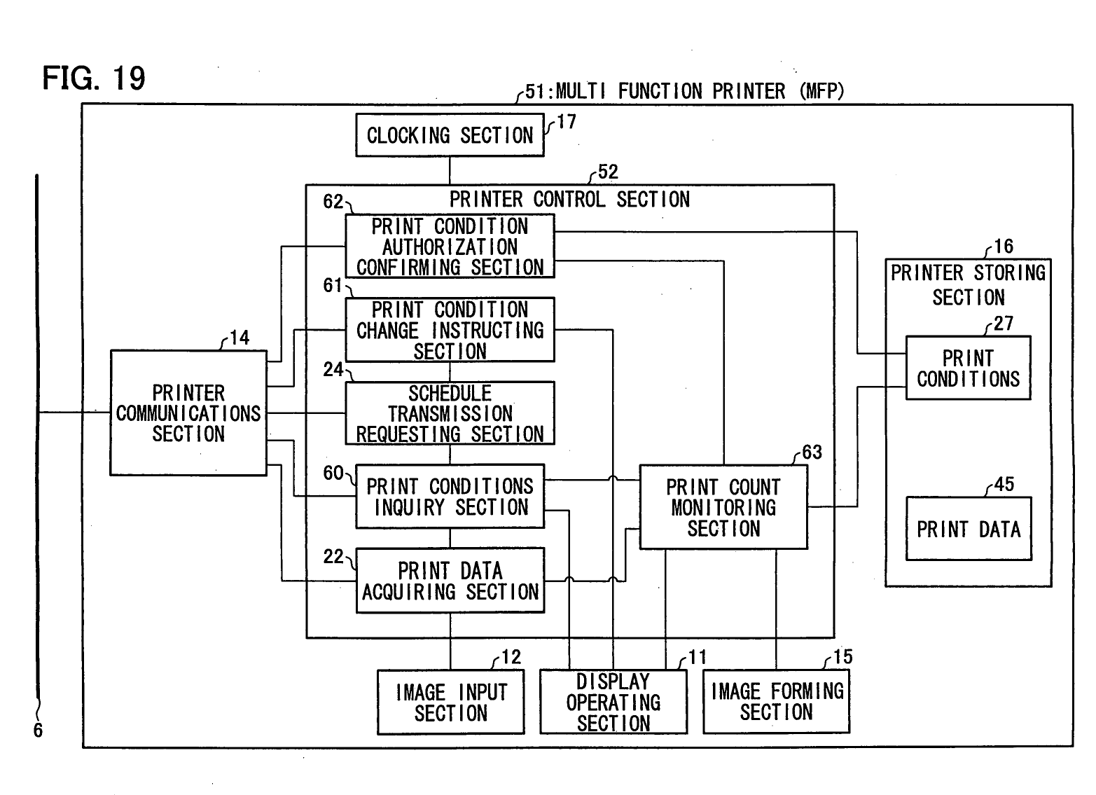

As shown in FIG. 19, the multi function printer 51 differs from the multi function printer 4 in the structures of the functional blocks provided in a printer control section 52. Specifically, the functional blocks provided in the printer control section 52 differ from those of the printer control section 13 of the First Embodiment in that they include a print conditions authorization confirming section 62, a print conditions change instructing section (change authorization confirming section) 61, and a print conditions inquiry section (change request confirming section, unprocessed print information notifying section, schedule selecting and outputting section) 60, instead of the authorization confirming section 23, the settings change instructing section 25, and the settings change inquiry section 20, respectively.

FIG. 19 is a block diagram schematizing an exemplary structure of the multi function printer (MFP) 51 according to the Second Embodiment of the present invention.

In a print job carried out based on print data 45, the print conditions inquiry section 60 (change request confirming section, unprocessed print information notifying section, schedule selecting and outputting section) asks a user whether the printed sheets in the print job is to be counted from the range of allocated print count of user, or from the range of separate print count. The print conditions inquiry section 60 then receives and analyzes a user reply.

Upon receipt of the print data 45 form the image input section 12, the print data acquiring section 22 notifies the print conditions inquiry section 60 that the print data 45 has been acquired. In response to the notification from the print data acquiring section 22, the print conditions inquiry section 60 instructs the display operating section 11 to make an inquiry to the user. A user reply entered through the display operating section 11 is received and analyzed by the print conditions inquiry section 60. Note that, in making an inquiry to the user, the print conditions inquiry section 60 preferably sends to the user thumbnail information indicative of content of the print data 45.

The print count monitoring section 63, together with the print conditions inquiry section 60, realizes the unprocessed information notifying section.

As a result of analysis, if the user has requested that prints in the print job be counted within the print count separately provided from the allocated print count of user, the schedule transmission requesting section 24 is requested to receive schedules of the user.

On the other hand, if the user is not requesting to use the separate print count, the print count monitoring section 63 is instructed to carry out the print job based on the print data 45 acquired by the print data acquiring section 22, using the allocated print count of user.

At the request of the print conditions change instructing section 61 (change authorization confirming section), the manager terminal 3 counts prints in the print job, using a print count separately provided from the print count allocated to the user requesting the print job.

Namely, the schedule transmission requesting section 24 receives the user schedules from the schedule management unit 5, and, from the schedules, allows the user to select a schedule corresponding to the print data 45 to be printed.

With the schedule selected by the user, the schedule transmission requesting section 24 sends instructions so that the manager terminal 3 is requested to use the separate print count in counting the number of printed sheets in the print job. According to the instructions from the schedule transmission requesting section 24, the print conditions change instructing section 61 sends the request to the manager terminal 3 together with the selected schedule of the user. Note that, the print conditions inquiry section 60, together with the display operating section 11, realizes the schedule selecting and outputting section.

In sending the selected schedule of the user and the request to the manager terminal 3, thumbnail information of the print data 45 may be sent together as well. The thumbnail information is created by the print conditions change instructing section 61 based on the print data 45 acquired by the print data acquiring section 22.

The print conditions authorization confirming section 62 (change authorization confirming section) receives a reply from the manager terminal 3 concerning the request sent from the print conditions change instructing section 61 to the manager terminal 3, and analyzes the content of the reply.

If the reply from the manager terminal 3 authorizes the request, the print conditions authorization confirming section 62 requests the print count monitoring section 63 to send print job instructions to the image forming section 15, and instructs the print count monitoring section 63 to use the separate print count in counting the number of printed sheets in the print job.

On the other hand, if the reply from the manager terminal 3 does not authorize the request, the print conditions authorization confirming section 62 sends print job instructions to the image forming section 15, and instructs the print count monitoring section 63 to use the allocated print count of the user in counting the number of printed sheets in the print job.

Note that, the print conditions authorization confirming section 62, together with the print conditions change instructing section 61, realizes the change authorization confirming section.

Further, the print count monitoring section 63, together with the print conditions authorization confirming section 62, realizes the print quantity notifying section. Specifically, with the print job performed by the image forming section 15 based on the print data 45, the print count monitoring section 63 counts the number of printed sheets made in the print job. The resulting print count is then sent to the schedule management unit 5 via the print condition authorization section 62.

The multi function printer 51 according to the present embodiment differs from the print count monitoring section 21 of the First Embodiment in the following respect. Namely, in performing a print job within the upper limit of separate print count, the print count monitoring section 63 uses the separate print count, not the allocated print count of the user, in counting the number of printed sheets made in the print job.

(Print Job in Copying)

Referring to FIG. 15, the following will describe a print job in which the print data 45 is read by the image input section 12 of the multi functional printer 51 as in copying. FIG. 15 is a flow chart of an exemplary print job performed based on the print data 45 read in the multi function printer 51 according to another embodiment (Second Embodiment) of the present invention.

As shown in FIG. 15, the image input section 12 of the multi function printer 51 reads the print data 45 from a print document supplied by the user (S90). In supplying a print document to the multi function printer 51, the user enters the account information 72, identifying the user, in the multi function printer 51, as in the First Embodiment.

After reading the print data 45, the multi function printer 51 makes an inquiry to the user whether to make a request for performing a print job using a print count separately provided from the allocated print count of the user (S91).

More specifically, with the print data 45 read by the image input section 12, the multi function printer 51 sends the print data 45 to the print data acquiring section 22. Upon receipt of the print data 45, the print data acquiring section 22 notifies the print condition inquiry section 60 that the print data 45 has been read. Note that, in the multi function printer 51, the print data 45 is stored in the printer storing section 16 after it has been read.

With the notification from the print data acquiring section 22, the print condition inquiry section 60 instructs the display operating section 11 to display an inquiry concerning whether to count the number of printed sheets using a print count separately provided from the allocated print count setting the upper limit. According to the instructions from the print condition inquiry section 60, the display operating section 11 displays the inquiry through the output section such as a display device.

With the displayed inquiry, the print condition inquiry section 60 creates thumbnail information based on the print data 45 acquired by the print data acquiring section 22. With the inquiry, the display operating section 11 may display the print data 45 in thumbnails.

With the print data 45 displayed in thumbnails, the user, by referring to the displayed thumbnails, can easily grasp the content of print data 45 for which the inquiry is made by the multi function printer 51.

In response to the inquiry displayed in the display operating section 11, the user enters instructions concerning whether to request a print job using a separate print count, using the input section such as a touch panel. The user instructions are sent to the print condition inquiry section 60 from the display operating section 11, and the print condition inquiry section 60 analyzes the user instructions.

If the result of analysis by the print inquiry section 60 reveals that the user does not wish to perform copying of the print data 45 using the separate print count (No in S91), a print job is carried out within the allocated print count setting the upper limit (S92). When the print job is finished (S93), the user is notified of the end of print job (S94).

Namely, if No in S91, the print condition inquiry section 60 instructs the print data acquiring section 22 to send the print data 45 to the print count monitoring section 63. Upon receipt of the print data 45 from the print data acquiring section 22, the print count monitoring section 63 instructs the image forming section 15 to carry out a print job based on the print data 45, while monitoring the upper limit of allocated print count. According to the instructions from the print count monitoring section 63, the image forming section 15 performs the print job.

If, on the other hand, the user wishes to perform copying of the print data 45 within the separate print count (Yes in S91), the print condition inquiry section 60 requests the schedule management unit 5 to send schedules (S95). With the schedules received from the schedule management unit 5 (S96), the print condition inquiry section 60 sends the schedules to the manager, and at the same time requests the manager to authorize carrying out a print job within the print count separately provided from the allocated print count of user (S97).

That is, if Yes in S91, the print condition inquiry section 60 instructs the schedule transmission requesting section 24 to request for transmission of user schedules.

According to instructions from the print condition inquiry section 60, the schedule transmission requesting section 24 requests the schedule management unit 5 to send schedules of the user. The schedules sent from the schedule management unit 5 are received by the schedule transmission requesting section 24. Note that, it is preferable that the user schedules received by the schedule transmission requesting section 24 do not include schedules that have been processed.

The schedule transmission requesting section 24 then instructs the display operating section 11 to display the received schedules. From the displayed schedules, the user is asked to select a schedule corresponding to the print data 45 for which a print job is to be performed. The user selects a suitable schedule through the input section of the display operating section 11, and sends the schedule to the multi function printer 51.

Note that, as in the First Embodiment, the display operating section 11 displays the schedules such that processed schedules and unprocessed schedules are displayed separately, in order to prevent processed schedules from being selected.

In the multi function printer 51, the selected schedule is received by the schedule transmission requesting section 24 and forwarded to the print condition change instructing section 61. The schedule transmission requesting section 24 then instructs the print condition change instructing section 61 and thereby requests the manager terminal 3 to count the number of printed sheets in the print job from the print count separately provided from the allocated print count of user.

According to the instructions from the schedule transmission requesting section 24, the print condition change instructing section 61 sends the selected schedule of the user to the manager terminal 3 via the printer communications section 14, and at the same time makes the request. In making the request, the print condition change instructing section 61 sends a signal to the clock section 17, so as to instruct the clock section 17 to manage a response time of the manager terminal 3 responding to the request.

Note that, in making a request to the manager terminal 3, the print condition change instructing section 61 sends thumbnail information of the print data 45.

If a reply from the manager terminal 3 is received within a predetermined time period (Yes in S98), the multi function printer 51 determines whether the reply from the manager terminal 3 authorizes carrying out the print job within the separate print count (S101).

Specifically, the print condition change instructing section 61 requests the manager terminal 3 to authorize carrying out the print job using the separate print count. If the print condition authorization confirming section 62 receives a reply from the manager terminal 3 within a predetermined time period, the print condition authorization confirming section 62 analyzes the content of the reply received from the manager terminal 3. From the result of analysis, the print condition authorization confirming section 62 determines whether the reply from the manager terminal 3 authorizes the request.

If the print condition authorization confirming section 62 determines that the reply from the manager terminal 3 does not authorize the request (No in S101), the print condition authorization confirming section 62 instructs the print count monitoring section 63 to perform the print job within the allocated print count setting the upper limit.

According to the instructions from the print condition authorization confirming section 62, the print count monitoring section 63 sends the print data 45 acquired in the print data acquiring section 22 to the image forming section 15, so as to carry out a print job (S92). This is carried out while monitoring the print count of the print data 45 being printed in the image forming section 15, by referring to the print conditions 27 of the user.

On the other hand, if the print condition authorization confirming section 62 determines that the reply from the manager terminal 3 authorizes the request (Yes in S101), the print condition authorization confirming section 62 instructs the print count monitoring section 63 to carry out a print job. According to the instructions from the print condition authorization confirming section 62, the print count monitoring section 63 sends the print data 45 acquired in the print data acquiring section 22 to the image forming section 15, so as to carry out a print job (S102).

The print count monitoring section 63 performs a print job within the print count separately provided from the allocated print count of the user, so that the number of printed sheets made in the print job is not counted from the allocated print count of the user.

Note that, for example, in the case where the separate print count sets the upper limit for each specific group to which the user belongs, it is preferable that the schedule management unit 5 be notified of the number of printed sheets made in the print job, so that the number of printed sheets is counted from the print count allocated to the specific group.

Further, in the case where the print job is carried out within the upper limit of print count allocated to the specific group, the user is asked to select the specific group in S91. Alternatively, a reply from the manager terminal may specify a specific group to which the upper limit of print count is assigned.

If a reply from the manager terminal is not received within a predetermined time period (No in S98), a print job is carried out within the allocated print count of the user (time out) (S92).

Specifically, if a predetermined time period is passed from the time the request was made by the print condition change instructing section 61, the clock section 17 sends a signal to the print condition authorization confirming section 62 in order to notify as such. If the print condition authorization confirming section 62 does not receive the reply from the manager terminal 3 before the print condition authorization confirming section 62 receives a signal from the clock section 17, the print condition authorization confirming section 62 instructs the print count monitoring section 63 to perform a print job within the allocated print count of the user (time out). According to the instructions from the print condition authorization confirming section 62, the print count monitoring section 63 instructs the image forming section 15 to perform a print job based on the print data 45. This is carried out while monitoring whether the number of printed sheets being made in the print job is within the allocated print count of the user.

Note that, the print condition authorization confirming section 62, together with the clock section 17, realizes the response time setting section.

After the print job, the print count monitoring section 63 notifies that the print job has been finished, and instructs the display operating section 11 to display the number of printed sheets made in the print job. The print count monitoring section 63 rewrites the print conditions 27 stored in the printer storing section 16, by subtracting the print count resulting from the print job from the allocated print count corresponding to the account information 72 of the user who has requested the print job.

Note that, the system may be adapted so that, in steps S92 through S94, the multi function printer 51 can request the manager terminal 3 to change the upper limit when the print count reaches the upper limit of print count allocated to the user in the manner described in the First Embodiment. In this case, the multi function printer 51 additionally includes the authorization confirming section 23, the settings change instructing section 25, and the settings change inquiry section 20, which are provided in the multi function printer 4.

(Print Job Based on Print Instructions from User Terminal)

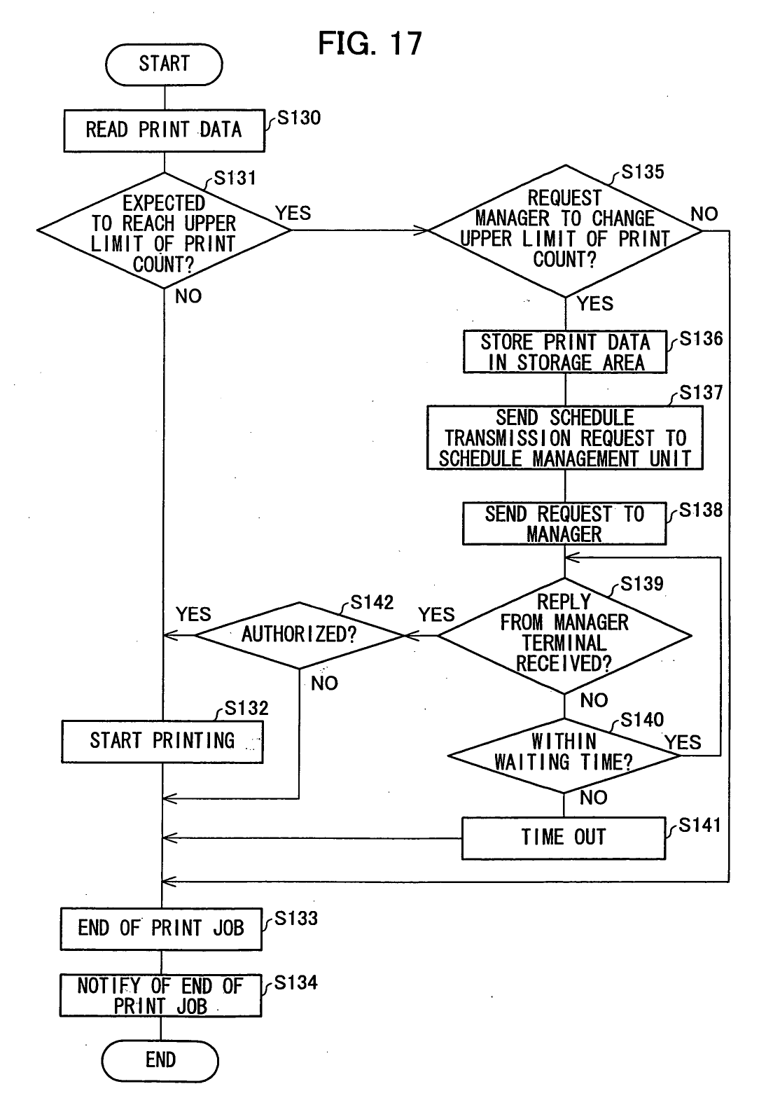

Referring to FIG. 16, the following will describe a print job carried out in the print management system 50 according to the present embodiment (Second Embodiment), in which the user terminal 2 sends the print data 45 to the multi function printer 51. FIG. 16 is a flow chart of an exemplary print job performed based on print instructions from the user terminal 2 in the print management system 50 according to the Second Embodiment of the present invention.

It should be noted here that the processing steps are performed by the user terminal control section 162 of the user terminal 2.

Before the print processing section 171 in the user terminal 2 sends the print data 45 stored in the user terminal storing section 161 to the multi function printer 51, the user terminal 2 carries out the following procedure. Namely, the user terminal 2 asks the user whether the number of printed sheets to be made in the print job will be counted from the allocated print count of the user, or from the separate print count (S110).

Note that, an inquiry concerning whether to carry out a print job is displayed on the output section such as a display device provided in the user terminal 2, so as to allow the user to give print instructions to the multi function printer 51 through the input section of the user terminal input/output section 160.

In making an inquiry, the user terminal input/output section 160 may display the print data 45 in thumbnails. With the thumbnail display of the print data 45, the user can easily grasp the content of the print data 45.

In answering the inquiry, the user can choose his or her option through the input section such as a keyboard provided in the user terminal input/output section 160.

If the user chooses to perform a print job of the print data 45 within the allocated print count of the user (No in S110), the print data 45 is directly sent to the multi function printer 51 (S111).

In sending the print data 45 to the multi function printer 51, the user terminal 2 sends information indicative of a print job to be performed within the allocated print count of the user, together with the account information 72 of the user.

When the print job performed based on the print data 45 sent from the user terminal 2 is finished, the multi function printer 51 sends information indicating that the print job has been finished. Together, information indicative of the number of printed sheets made in the print job is sent out. The information from the multi function printer 51 is received by the user terminal 2 (S112), and the processes of the user terminal 2 are finished.

On the other hand, if the user chooses to perform a print job of the print data 45 using a print count separately provided from the allocated print count of the user (Yes in S110), the user terminal 2 requests the schedule management unit 5 to send schedules (S113).

In sending a request for schedule transmission, the user from the user terminal 2 sends his or her account information 72 to the schedule management unit 5, together with information concerning the print data 45 to be printed.

The schedule stored in the schedule management unit 5 is related to the account information 72 of each user. Further, the schedule contains data indicative of purpose of the print job, and print data. Thus, with the account information 72 and the information of print data 45 received from the user terminal 2, the schedule management unit 5 can send schedules corresponding to the print data 45 to the user terminal 2.

Note that, it is preferable that the schedules sent from the schedule management unit 5 be sorted such that the user is prevented from selecting processed schedules.

With the schedules received (S114), the user terminal 2 requests the manager terminal 3 to perform a print job using a print count separately provided from the allocated print count of the user (S115).

If the user terminal 2 receives a reply from the manager terminal 3 concerning the request made by the user terminal 2 (Yes in S116), the user terminal 2 determines whether the content of the reply authorizes the request (S119).

The content of the reply from the manager terminal 3 can be confirmed by displaying it on the output section of the user terminal 2, for example.

If the reply from the manager terminal 3 authorizes the request (Yes in S119), the user terminal 2 sends the print data 45 to the multi function printer 51, together with information indicative of that the request for carrying out a print job using the separate print count has been authorized (S120).

On the other hand, if No in S119, the print data 45 is sent to the multi function printer 51, and a notification is sent to inform that the print job is to be performed within the allocated print count of the user.

If it is determined in S116 that a reply from the manager terminal 3 has not been received (No in S116), the user terminal 2 maintains a standby state and awaits a reply from the manager, if a predetermined waiting time set for the user terminal 2 has not been passed (Yes in S117).

If a reply from the manager terminal 3 is not received after the predetermined time period (No in S117), the system decides time out (S118), and the user terminal 2 sends the print data to the multi function printer 51, and sends a notification to indicate that the print job is to be performed within the allocated print count of the user.

As described above, the print management system 50 according to the present embodiment (Second Embodiment) is adapted so that the user is allowed to choose whether a print job is to be carried out within the allocated print count of user, or separate print count.

Thus, if the content of print data is not created by individual users but provide documents to be distributed to members of a group, the user can perform a print job using the separate print count allocated to the group, without using the print count allocated to the user.

Note that, the system may be adapted so that, while the user terminal 2 makes an inquiry, the multi function printer 51 temporarily stores the print data 45 from the user terminal 2 in the printer storing section 16. In this case, S111 in FIG. 16 is carried out before S110.

It should be noted that the components and the process steps in the multi function printer 4 of the foregoing embodiment are realized by a CPU or other computing section executing a program stored in a ROM (Read Only Memory), RAM, or other storage device to control an input section such as keyboard and touch panel, an output section such as display, or communications section such as interface circuit. Therefore, a computer having these components can realize various functions and various processes in the multi function printer 4 of the present embodiment only by reading a storage medium storing the program and executing the program. Further, storage of the program into a removable storage medium realizes implementation of the same functions and processes on any computer.

The storage medium may be a memory (not shown) for process steps on a microcomputer. For example, the program medium may be something like a ROM. Alternatively, the program medium may be such that a program reader device (not shown) as an external storage device may be provided in which a storage medium is inserted for reading.

In addition, in any case, the stored program is preferably executable on access by a microprocessor. Further, it is preferred if the program is retrieved, and the retrieved program is downloaded to a program storage area in a microcomputer to execute the program. The download program is stored in a main body device in advance.

In addition, the program medium may be a storage medium constructed separably from a main body. The medium may be tapes, such as a magnetic tape or cassette tape; discs, such as a flexible disc or hard disk including a magnetic disc and CD/MO/MD/DVD; cards, such as an IC card (including a memory card); or a semiconductor memory, such as a mask ROM, EPROM (Erasable Programmable Read Only Memory), EEPROM (Electrically Erasable Programmable Read Only Memory), and a flash ROM. All these types of media hold the program in a fixed manner.

In contrast, the system is arranged to connect to the communications network 6 including the Internet, so that the medium is preferably a storage medium which holds the program in a flowing manner so that the program can be downloaded over the communications network 6.

Further, if the program is downloaded over the communications network 6 in this manner, it is preferred if the download program is either stored in a main body device in advance or installed from another storage medium.

### INDUSTRIAL APPLICABILITY

In a system where print job restrictions are set for each user requesting a print job, a printing apparatus according to the present invention includes a change authorization confirming section for confirming whether a manager authorized to specify settings of the print restrictions authorizes changing information of the print restrictions as requested by the user. The printing apparatus performs a print job with the print restrictions information changed by the user, if the change authorization confirming section confirms that the manager has authorized to change the print restrictions. Thus, security restrictions such as access limit set to each user can be suitably changed by the printing apparatus as required.

As described above, according to the present invention, there is provided a printing apparatus in which print restrictions concerning print jobs are set for each user requesting the print jobs, the printing apparatus including: a change authorization confirming section for confirming whether a manager authorized to specify settings of the print restrictions authorizes changing information of the print restrictions as requested by the user, the printing apparatus performing a print job with the print restrictions information changed by the user, if the change authorization confirming section confirms that the manager has authorized to change the print restrictions.

The print restrictions information refers to information concerning restrictions of print jobs, set for each user carrying out a print job on the printing apparatus. Examples of the print restrictions information include restrictions information allowing or disallowing the user from using the printing apparatus, and information of print count allocated to the user.

A printing apparatus according to the present invention is adapted to set print restrictions. Thus, for example, if print restrictions are set such that the user is allowed or disallowed to use the printing apparatus, only authorized users can perform print jobs.

Further, if the print restrictions set the upper limit of allowable print count (the number of printable sheets) for each user, there will be no wasteful print job carried out by the user. That is, with a printing apparatus according to the present invention, the cost of print job can be reduced.

Further, with the change authorization confirming section, the printing apparatus can perform a print job according to the content of new print restrictions of the user, if the change authorization confirming section confirmed that the manager has authorized to change the information of print restrictions.

That is, in a printing apparatus according to the present invention, a print job can be carried out based on content of new print restrictions if the manager has authorized to do so. Thus, with an authorization of the manager, a necessary print job can be performed even when it is prevented by the print restrictions.

That is, the printing apparatus can suppress the manager from handing out authorization and therefore changing print restrictions unnecessarily, and can perform a print job by appropriately changing settings of print restrictions as required.

Further, with the change authorization confirming section provided in the printing apparatus, the user is not required to go to the manager and obtain authorization for changing print restrictions if he or she wishes to change the print restrictions set for the user. Instead, the user can quickly obtain authorization for changing print restrictions, and the efficiency of print job can be improved.

Thus, with a printing apparatus according to the present invention, the cost of print job can be reduced, and the print job can be efficiently performed by changing the print restrictions as required by the print job.

Note that, as used herein, the term “managers” refers to those authorized to specify settings of print restrictions, and they include, for example, management staff for managing the work of users in a corporate organization.

In the foregoing configuration, a printing apparatus according to the present invention may be adapted so that the print restrictions information includes print quota information concerning a print quota assigned to the user.

As used herein, the “print quota” refers to a quantity of print job, for example, such as the number of printed sheets made in the print job. The “print quota information” refers to information indicative of a print quota assigned to the user carrying out a print job, for example, such as the number of printable sheets assigned to the user.

With the print restrictions information including the print quota information, the printing apparatus can set a print quota for the user and thereby suppress unnecessary print jobs. Thus, a printing apparatus according to the present invention can reduce the cost of printing.

Further, with the change authorization confirming section, the printing apparatus can confirm whether the manager authorizes changing the print quota information.

If the change authorization confirming section confirmed that the manager has authorized to change the print quota information, a print job can be carried out based on the new print quota.

Since the printing apparatus can perform a print job by changing the print quota under authority of the manager, a print job can be carried out under authority of the manager even when the assigned print quota of the user does not allow for a necessary print job.

That is, a printing apparatus according to the present invention requires authorization of the manager and therefore prevents the print quota from being freely changed. Further, a print job can be carried out by changing the print quota as required.

Further, with the change authorization confirming section, the printing apparatus can confirm whether the manager authorizes a user's request to change the print quota.

Thus, when the user would like to change the print quota, the user is not required to go to the manager and obtain his authorization. This enables the print job to be quickly carried out.

Thus, a printing apparatus according to the present invention can suppress a quantity of print job and therefore the cost of print job. Further, a print job can be carried out efficiently by changing the print quota as required.

In the foregoing configuration, it is preferable in a printing apparatus according to the present invention that the change authorization confirming section include a response time setting section for setting a response time concerning manager's authorization for changing the print restrictions information, and that the response time setting section vary the response time.

With the response time setting section, the printing apparatus can set a response time for the manager. The response time setting section is adapted to vary a response time, and therefore can suitably set a response time according to a response timing of the manager.

In the foregoing configuration, it is preferable in a printing apparatus according to the present invention that the change authorization confirming section be communicably connected to an information processing unit for storing print schedules of the user, and to a manager terminal used by the manager, and that the change authorization confirming section include a print schedule acquiring section for acquiring print schedules from the information processing unit, and send the print schedules acquired by the print schedule acquiring section to the manager terminal, so as to confirm whether the manager authorizes changing information of the print restrictions.

With the print schedule acquiring section, the printing apparatus can obtain print schedules, which are schedules concerning print jobs of the user, from the information processing unit.

Further, since the change authorization confirming section can send the print schedules to the manager terminal when confirming whether the manager authorizes changing the print restrictions information, the manager at the manager terminal can decide whether to authorize changing the print restrictions information by referring to the print schedules.

Thus, in the printing apparatus, since the change authorization confirming section sends the schedules acquired by the print schedule acquiring section to the manager and confirms whether the manager authorizes changing the restrictions information, the user is not required to go through a tedious process of explaining the manager the need to change the restrictions information and obtain his authorization.

In the foregoing configuration, a printing apparatus according to the present invention may be adapted so that the change authorization confirming section sends the print schedules to the manager terminal with image data concerning print data for which a print job is requested by the user, so as to confirm whether the manager authorizes changing the print quota.

That is, in the printing apparatus, the change authorization confirming section sends the print schedules to the manager terminal, together with image data of the print data. The image data may be for displaying thumbnails, for example.

Thus, through the image data, the manager is able to make visual confirmation of the content of the print data. This enables the manager to quickly make a decision whether or not to authorize changing the print quota.

Thus, in the printing apparatus, the user requesting the manager to change the print quota can quickly receive authorization of the manager, and therefore the print job can be carried out with less interruption.

In the foregoing configuration, a printing apparatus according to the present invention may be adapted to include: a quota determining section for determining the presence or absence of remains of the print quota assigned to the user; and a change request confirming section for confirming the user whether to request the manager terminal to change the print quota, when the quota determining section determines that the print quota does not remain.

That is, in the printing apparatus, whether to make a request for changing the print quota can be confirmed to the user when the print quota assigned to the user does not remain. Thus, in the printing apparatus, the user can figure out whether or not his or her print quota remains.

In the foregoing configuration, a printing apparatus according to the present invention may be adapted so that the quota determining section determines the presence or absence of remains of the print quota according to a quantity of printed copies actually made in the print job.

In the printing apparatus, the quota determining section can determine the presence or absence of remains of the assigned print quota according to the quantity of prints actually made in the print job. Thus, when the printed quantity in a print job reaches the upper limit of print quota, the printing apparatus can suitably notify the user that the print quota does not remain, and ask the user whether to make a request for changing the print quota.

That is, in the printing apparatus, the print quota can be changed according to the quantity of prints made in the print job.

In the foregoing configuration, a printing apparatus according to the present invention may be adapted so that the quota determining section determines the presence or absence of remains of the print quota based on content of print job instructions made by the user and before the print job is performed.

In this way, the printing apparatus can confirm the presence or absence of remains of the print quota before the print job is carried out, and is therefore able to request the manager terminal to change the print quota before the print job is carried out.

In the foregoing configuration, a printing apparatus according to the present invention may be adapted to include: a print suspending section for suspending the print job when the quota determining section confirms that the print quota does not remain; and an unprocessed data storing section for storing unprocessed print data which has not been processed at the time when the print job is suspended by the print suspending section.

With the print suspending section, the printing apparatus can prevent a print job from being carried out beyond the print quota. Further, with the unprocessed print data storing section, the printing apparatus can retain the unprocessed print data when the quantity of prints made in the print job reaches exceeds the print quota.

Further, the printing apparatus can efficiently carry out the print job even in the presence of print job instructions for a different print job. Specifically, with the unprocessed print data storing section, the printing apparatus can perform a print job even when another print job being performed according to separate instructions is suspended due to the print quota limitation. That is, the printing apparatus according to the present invention can carry out a print job without interruptions.

Further, with the unprocessed print information notifying section, the printing apparatus can immediately inform the user about the unprocessed print data. Thus, the printing apparatus can efficiently carry out the print job and quickly inform the user about the unprocessed print data.

In the foregoing configuration, a printing apparatus according to the present invention may be adapted to include an unprocessed print information notifying section for notifying the user of image data indicative of content of the unprocessed print data.

With the unprocessed print information notifying section, the printing apparatus enables the user to quickly grasp the content of unprocessed print data by referring to the output image data.

The user is therefore able to decide whether to request the manager terminal to change the print quota concerning the unprocessed print data.

Thus, in the printing apparatus, whether to change the print quota can be quickly decided even when the print quota is consumed.

In the foregoing configuration, a printing apparatus according to the present invention may be adapted so that the print job is finished if the change request confirming section confirms that the user does not make a request for changing the print quota.

Further, in the foregoing configuration, a printing apparatus according to the present invention may be adapted so that the print restrictions information includes print quota information concerning a print quota assigned to the user, and separate print quota information concerning a print quota assigned to the user on special occasions, that the change authorization confirming section confirms whether the manager authorizes performing a print job within the separate print quota, if the user has requested to perform a print job within the separate print quota, and that the change authorization confirming section changes the assigned print quota of the user to the separate print quota to perform a print job, if the change authorization confirming section confirms that the manager authorizes performing the print job within the separate print quota.

With the preset print quota assigned to the user, the printing apparatus can restrain unnecessary print jobs of the user.

Further, with the additional print quota, the user can perform a print job by choosing a print quota. As used herein, “special occasions” refers to situations where an unexpected print job is necessitated, for example, by an unexpected visit of an important client. Namely, the separate print quota is a spare quota reserved for an unexpected print job as exemplified above, and is provided, for example, as a spare quota additionally provided to the assigned print quota of the user, or as a spare quota for a plurality of users. In short, the separate print quota is the quota assigned to the user in addition to the preset print quota of each user. The separate print quota may assign a predetermined print quantity, or infinite print quantity.

Further, with the change authorization confirming section, the printing apparatus enables the user to carry out the print job using the separate print count, by requesting the manager to authorize changing the assigned print quota of the user to the separate print quota according to the importance or content of the print job.

Thus, the printing apparatus can perform a print job within the separate print quota according to the content or importance of the print job. Further, because the switch to the separate print quota is made with the authorization of the manager operating the manager terminal, the separate print quota will not be selected unnecessarily.

Thus, the printing apparatus according to the present invention can reduce the cost of print job, and can efficiently carry out a print job by changing the print restrictions according to the importance or content of the print job.

Further, in the foregoing configuration, a printing apparatus according to the present invention may be adapted so that the printing apparatus is communicably connected to an information processing unit for storing print schedules of the user, and to a manager terminal used by the manager, and that the change authorization confirming section includes a print schedule acquiring section for acquiring print schedules from the information processing unit, and sends the print schedules acquired by the print schedule acquiring section to the manager terminal, so as to confirm whether the manager authorizes changing the assigned print quota of the user to the separate print quota.

With the print schedule acquiring section, the printing apparatus can obtain print schedules, which are schedules concerning print jobs of the user, from the information processing unit.

Further, since the change authorization confirming section can send the print schedules to the manager terminal when confirming whether the manager authorizes changing the print quota to the separate print quota, the manager at the manager terminal can decide whether to authorize changing the print quota to the separate print quota by referring to the print schedules.

Thus, in the printing apparatus, since the change authorization confirming section sends the schedules acquired by the print schedule acquiring section to the manager and confirms whether the manager authorizes changing the print quota to the separate print quota, the user is not required to go through a tedious process of explaining the manager the need to change the print quota and obtain his authorization.

Further, in the foregoing configuration, a printing apparatus according to the present invention may be adapted so that the change authorization confirming section sends the print schedules to the manager terminal with image data concerning print data for which a print job is requested by the user, so as to confirm whether the manager authorizes changing the assigned print quota of the user to the separate print quota.

Thus, in the printing apparatus, the change authorization confirming section sends the print schedules to the manager terminal, together with image data of the print data.

Thus, through the image data, the manager is able to make visual confirmation of the content of the print data, and thereby confirm the (print) schedules of the print data. This enables the manager to quickly make a decision whether or not to authorize changing the print quota to the separate print quota.

The image data may be for displaying thumbnails, for example.

Thus, in the printing apparatus, the user requesting the manager to change the print quota to the separate print quota can quickly receive authorization of the manager, and therefore the print job can be carried out with less interruption.

Further, in the foregoing configuration, it is preferable that the printing apparatus according to the present invention include a schedule selecting and outputting section for outputting to the user the print schedules acquired by the print schedule acquiring section, so as to allow the user to select therefrom a print schedule corresponding to the print data.

With the schedule selecting section, the printing apparatus can enable the user to select a schedule corresponding to the print data for which a print job is to be performed. The printing apparatus can therefore output the schedule corresponding to the print data to the manager, and the manager is therefore able to quickly confirm whether the user's request for changing restrictions is made with respect to print data corresponding to which schedule.

Thus, in the printing apparatus according to the present invention, the manager can quickly decide whether to authorize the change.

Further, in the foregoing configuration, it is preferable in the printing apparatus according to the present invention that the printing apparatus is communicably connected to the information processing unit creating print data, and that the schedule selecting and outputting section outputs the print schedules to the information processing unit creating print data.

Thus, in a printing apparatus according to the present invention, the schedule selecting section can send the schedules to the information processing unit creating print data. Thus, in operating the information processing unit and instructing the printing apparatus to carry out a print job of the print data, the user can send instructions by confirming the schedules acquired by the schedule acquiring section.

That is, from the schedules transmitted from the printing apparatus, the user can select a schedule corresponding to the print data to be processed.

Further, in the foregoing configuration, the printing apparatus according to the present invention may be adapted so that the schedule selecting and outputting section outputs the print schedules without containing print schedules that have been processed.

Since the schedule selecting section outputs the print schedules without containing processed schedules, the user confirming the schedules concerning the print job is not required to check schedules concerning print jobs that are not required. That is, the printing apparatus according to the present invention enables the user to quickly check schedules, and prevents processed schedules from being selected.

Further, in the foregoing configuration, it is preferable that the printing apparatus according to the present invention include a printed quantity notifying section for notifying, after a print job, the information processing unit storing the print schedules about a quantity of prints made in the print job.

With the print quantity notifying section, the printing apparatus can notify the information processing unit storing the print schedules about a quantity of prints made in the print job.

Thus, the information processing unit storing the print schedules can record and manage the result of print job by correlating the print schedules with the quantity of prints actually made in the print job.

The schedule selecting and outputting section may be adapted so that the print schedules are sent without containing processed print schedules.

Further, it is preferable that the printing apparatus be adapted to include a print count notifying section for notifying, after a print job, the information processing unit storing the print schedules about the number of printed sheets made in the print job.

With the print count notifying section, the printing apparatus can notify the information processing unit storing the print schedules about the number of sheets used in the print job.

Thus, the information processing unit storing the print schedules can record and manage the result of print job by correlating the print schedules with the number of sheets actually used in the print job.

Note that, the printing apparatus may be realized by a computer. In this case, the present invention includes a computer-readable storage medium storing a control program for the printing apparatus, wherein the program controls the computer to function as the respective members of the printing apparatus.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1. A printing apparatus in which print restrictions concerning print jobs are set for each user requesting the print jobs, comprising:
a change authorization confirming section for confirming whether a manager authorized to specify settings of the print restrictions authorizes changing information of the print restrictions as requested by the user,
said printing apparatus performing a print job with the print restrictions information changed by the user, if the change authorization confirming section confirms that the manager has authorized to change the print restrictions.

2. The printing apparatus as set forth in claim 1, wherein the print restrictions information comprises print quota information concerning a print quota assigned to the user.

3. The printing apparatus as set forth in claim 2, wherein:
the change authorization confirming section includes a response time setting section for setting a response time concerning manager's authorization for changing the print restrictions information, wherein the response time setting section varies the response time.

4. The printing apparatus as set forth in claim 1,
wherein the printing apparatus is communicably connected to an information processing unit for storing print schedules of the user, and to a manager terminal used by the manager, and
wherein the change authorization confirming section includes a print schedule acquiring section for acquiring print schedules from the information processing unit, and sends the print schedules acquired by the print schedule acquiring section to the manager terminal, so as to confirm whether the manager authorizes changing information of the print restrictions.

5. The printing apparatus as set forth in claim 4, wherein the change authorization confirming section sends the print schedules to the manager terminal with image data concerning print data for which a print job is requested by the user, so as to confirm whether the manager authorizes changing the print quota.

6. The printing apparatus as set forth in claim 5, wherein the image data concerning print data is for displaying the print data in the form of an image list.

7. The printing apparatus as set forth in claim 2, comprising:
a quota determining section for determining the presence or absence of remains of the print quota assigned to the user; and
a change request confirming section for confirming the user whether to request the manager terminal to change the print quota, when the quota determining section determines that the print quota does not remain.

8. The printing apparatus as set forth in claim 7, wherein the quota determining section determines the presence or absence of remains of the print quota according to a quantity of printed copies actually made in the print job.

9. The printing apparatus as set forth in claim 7, wherein the quota determining section determines the presence or absence of remains of the print quota based on content of print job instructions made by the user and before the print job is performed.

10. The printing apparatus as set forth in claim 7, further comprising:
a print suspending section for suspending the print job when the quota determining section confirms that the print quota does not remain; and
an unprocessed data storing section for storing unprocessed print data which has not been processed at the time when the print job is suspended by the print suspending section.

11. The printing apparatus as set forth in claim 10, further comprising an unprocessed print information notifying section for notifying the user of image data indicative of content of the unprocessed print data.

12. The printing apparatus as set forth in claim 7, wherein the print job is finished if the change request confirming section confirms that the user does not make a request for changing the print quota.

13. The printing apparatus as set forth in claim 1,
wherein the print restrictions information includes print quota information concerning a print quota assigned to the user, and separate print quota information concerning a print quota assigned to the user on special occasions,
wherein the change authorization confirming section confirms whether the manager authorizes performing a print job within the separate print quota, if the user has requested to perform a print job within the separate print quota; and
wherein the change authorization confirming section changes the assigned print quota of the user to the separate print quota to perform a print job, if the change authorization confirming section confirms that the manager authorizes performing the print job within the separate print quota.

14. The printing apparatus as set forth in claim 13, wherein the printing apparatus is communicably connected to an information processing unit for storing print schedules of the user, and to a manager terminal used by the manager, and
wherein the change authorization confirming section includes a print schedule acquiring section for acquiring print schedules from the information processing unit, and sends the print schedules acquired by the print schedule acquiring section to the manager terminal, so as to confirm whether the manager authorizes changing the assigned print quota of the user to the separate print quota.

15. The printing apparatus as set forth in claim 14, wherein the change authorization confirming section sends the print schedules to the manager terminal with image data concerning print data for which a print job is requested by the user, so as to confirm whether the manager authorizes changing the assigned print quota of the user to the separate print quota.

16. The printing apparatus as set forth in claim 15, wherein the image data concerning print data is for displaying the print data in the form of an image list.

17. The printing apparatus as set forth in claim 4, comprising a schedule selecting and outputting section for outputting to the user the print schedules acquired by the print schedule acquiring section, so as to allow the user to select therefrom a print schedule corresponding to the print data.

18. The printing apparatus as set forth in claim 14, comprising a schedule selecting and outputting section for outputting to the user the print schedules acquired by the print schedule acquiring section, so as to allow the user to select therefrom a print schedule corresponding to the print data.

19. The printing apparatus as set forth in claim 17,
wherein the printing apparatus is communicably connected to the information processing unit creating print data, and
wherein the schedule selecting and outputting section outputs the print schedules to the information processing unit creating print data.

20. The printing apparatus as set forth in claim 18,
wherein the printing apparatus is communicably connected to the information processing unit creating print data, and
wherein the schedule selecting and outputting section outputs the print schedules to the information processing unit creating print data.

21. The printing apparatus as set forth in claim 17, wherein the schedule selecting and outputting section outputs the print schedules without containing print schedules that have been processed.

22. The printing apparatus as set forth in claim 18, wherein the schedule selecting and outputting section outputs the print schedules without containing print schedules that have been processed.

23. The printing apparatus as set forth in claim 19, wherein the schedule selecting and outputting section outputs the print schedules without containing print schedules that have been processed.

24. The printing apparatus as set forth in claim 20, wherein the schedule selecting and outputting section outputs the print schedules without containing print schedules that have been processed.

25. The printing apparatus as set forth in claim 4, comprising a printed quantity notifying section for notifying, after a print job, the information processing unit storing the print schedules about a quantity of prints made in the print job.

26. The printing apparatus as set forth in claim 14, comprising a printed quantity notifying section for notifying, after a print job, the information processing unit storing the print schedules about a quantity of prints made in the print job.

27. A print control program for operating a printing apparatus, the program controlling a computer to function as:
a change authorization confirming section for confirming whether a manager authorized to specify settings of print restrictions authorizes changing information of the print restrictions as requested by a user requesting a print job;
a response time setting section for setting a response time concerning manager's authorization for changing the print restrictions information;
a print schedule acquiring section for acquiring print schedules from an information processing unit storing print schedules of the user;
a quota determining section for determining the presence or absence of remains of a print quota assigned to the user;
a request change confirming section for confirming whether the user requests the manager terminal to change the print quota, if the quota determining section determines that the print quota does not remain;
a print suspending section for suspending the print job, if the quota determining section confirms that the print quota does not remain;
an unprocessed print information notifying section for notifying the user of image data indicative of content of unprocessed print data;
a schedule selecting and outputting section for outputting to the user the print schedules acquired by the print schedule acquiring section, so as to allow the user to select therefrom a print schedule corresponding to the print data; and
a printed quantity notifying section for notifying, after a print job, the information processing unit storing the print schedules about a quantity of prints made in the print job.

28. A computer-readable storage medium storing a print control program for operating a printing apparatus, the program controlling a computer to function as:
a change authorization confirming section for confirming whether a manager authorized to specify settings of print restrictions authorizes changing information of the print restrictions as requested by a user requesting a print job;
a response time setting section for setting a response time concerning manager's authorization for changing the print restrictions information;
a print schedule acquiring section for acquiring print schedules from an information processing unit storing print schedules of the user;
a quota determining section for determining the presence or absence of remains of a print quota assigned to the user;
a request change confirming section for confirming whether the user requests the manager terminal to change the print quota, if the quota determining section determines that the print quota does not remain;
a print suspending section for suspending the print job, if the quota determining section confirms that the print quota does not remain;
an unprocessed print information notifying section for notifying the user of image data indicative of content of unprocessed print data;
a schedule selecting and outputting section for outputting to the user the print schedules acquired by the print schedule acquiring section, so as to allow the user to select therefrom a print schedule corresponding to the print data; and
a printed quantity notifying section for notifying, after a print job, the information processing unit storing the print schedules about a quantity of prints made in the print job.
